(19) United States
(12) Patent Application Publication
(10) Pub. No.: US 2021/0111615 A1
(43) Pub. Date: Apr. 15, 2021

(54) MAGNETIC ELECTRIC POWER STATION

(71) Applicant: Darrell Schmidt Enterprises, Inc., Brenham, TX (US)

(72) Inventor: George N. Mitri, Brenham, TX (US)

(73) Assignee: Darrell Schmidt Enterprises, Inc., Brenham, TX (US)

(21) Appl. No.: 17/066,354

(22) Filed: Oct. 8, 2020

Related U.S. Application Data
(60) Provisional application No. 62/915,474, filed on Oct. 15, 2019.

(51) Int. Cl. H02K 21/04; H02K 1/17; H02K 1/27; H01M 10/46; H02S 40/38

(52) U.S. Cl. CPC H02K 21/046; H02K 1/17; H02S 40/38; H01M 10/465; H02K 1/27

(57) ABSTRACT

The system and method of the present disclosure is a stand-alone power generation and production system that obtains, stores, and transfers motive energy by utilizing one or more magnetic devices. Electrical energy is provided from a battery to a motor, mechanical energy is provided from the motor to a generator with the aid of a coupling device, and electrical energy is produced from the generator, which may be routed back to the batteries or to an external load. Any one or more of the motor, coupler, and generator may be a magnetically enhanced device with the use of specially configured permanent magnets to create enhanced magnetic fields. The enhanced magnetic devices increase the power output based on the same power input, and may require less power input to produce the same power output.

This application claims priority to U.S. provisional patent application No. 62/915,474, filed on Oct. 15, 2019, the entire content of which is incorporated herein by reference.

### BACKGROUND OF THE INVENTION

### Field of the Invention

This invention relates to electric power stations, and more particularly to the use of magnetic devices within an electric power station to produce electrical energy at an enhanced output.

### Description of the Related Art

The present disclosure relates generally to an electric power station (hereinafter, EPS), and more particularly to a hybrid energy storage and conversion apparatus and method to produce and distribute electrical energy, such as that described in U.S. Pat. No. 9,768,632 (“the '632 patent”), incorporated herein by reference. The '632 patent describes an electric power station that generally describes the interaction of a motor, coupler, and alternator, along with a battery system and control system for servicing an external load. Each of these components described in the '632 patent, and the processes related thereto and the overall control of the system, is incorporated herein by reference.

With the increasing demand for electrical power in industrial, commercial, and residential applications, the present electrical power services have become over taxed due to the growing demands Standalone power systems are inefficient and require significant inputs of resources (whether from solar, oil, gas, coal, etc.) for continued electrical energy production and servicing of external loads. While alternative energy sources are attractive, their ability to produce continuous, sustained energy for large service loads remains problematic. While the '632 patent is related to the present disclosure, the '632 patent does not describe the specific interactions of the processes or components as described herein, nor does it describe components that can use permanent magnets to enhance the magnetic flux of the system and devices as described herein.

A viable alternative energy system is needed that is more efficient and cost-effective than existing systems. A stand-alone electric power station is needed that can better transfer mechanical energy into electrical energy and electrical energy into mechanical energy. An electric power station is needed that can enhance the torque, RPM, and other characteristics of a motor or alternator without requiring additional (or at least minimal) electrical supply. An electric power station is needed that can utilize static magnetic fields created by permanent magnets that require no to minimal electrical input. An electric power station is needed that is environmentally sensitive, durable, cost-effective, quiet, easily transportable, and viable in a wide range of applications and operating conditions.

### SUMMARY

The system and method of the present disclosure is a stand-alone power generation and production system that obtains, stores, and transfers motive energy by utilizing one or more magnetic devices. Electrical energy is provided from a battery to a motor, mechanical energy is provided from the motor to a generator with the aid of a coupling device, and electrical energy is produced from the generator, which may be routed back to the batteries or to an external load. Any one or more of the motor, coupler, and generator may be a magnetically enhanced device with the use of specially configured permanent magnets to create enhanced magnetic fields. The enhanced magnetic devices increase the power output based on the same power input, and may require less power input to produce the same power output.

Disclosed is a magnetic electric power station (MEPS) that includes a battery system, a motor, a coupler, an alternator/generator, and a charger. The MEPS may comprise and/or be coupled to an external electrical power source (such as a solar assembly array) and one or more external loads. This system may be AC or DC based. The MEPS unit includes any one of the motor, coupler, or alternator as having a magnetically enhanced device. Two of the devices may comprise magnetically enhanced devices (such as motor and coupler, motor and alternator, or coupler and alternator). In still another embodiment, all three of the devices (motor, coupler, and alternator) may comprise a magnetically enhanced device. In still another embodiment, a plurality of magnetically enhanced couplers may be utilized in series between the motor and the alternator to provide an even greater power amplification factor for the MEPS system.

A method of power generation is disclosed that utilizes one or more magnetically enhanced devices as part of an energy generating electrical power station. The method may comprise providing power to a motor from a battery system, converting electrical energy into mechanical energy via the motor, transferring mechanical energy from the motor to an alternator/generator, and converting mechanical energy into electrical energy via the alternator/generator. The method may further include servicing one or more loads from the produced electrical energy and/or charging one or more battery systems from the produced electrical energy. The method may include providing a passive magnetic field to the motor by the use of permanent magnets coupled to the motor, such as the rotor. The method may include providing a passive magnetic field to the generator by the use of permanent magnets coupled to the generator, such as within the stator and/or an additional housing around the input shaft. The method may include providing a passive magnetic field to the output shaft of the motor, the input shaft of the alternator, and/or a direct mechanical coupling between these shafts by the use of a magnetic coupler.

In some embodiments, multiple magnetic devices may be used simultaneously to create further magnetic enhancements to the EPS. The control system for the MEPS may be configured to vary and/or modify the applied magnetic fields from each of the magnetic motor, magnetic alternator, and magnetic coupler to produce the desired system output at any particular moment in time, whether it is used for charging the batteries or for servicing an electric load. Thus, the method may further include monitoring any one or more of the applied magnetic fields as well as RPMs and torque of the shaft(s) and varying the magnetic field(s) to produce the desired result(s). The use of a magnetic device (such as a coupler) enhances the power output by a factor of 2, while the use of two magnetic devices (such as a coupler and a motor, or two couplers in series) enhances the power output by a factor of 4, while the use of three magnetic devices (such as a coupler, motor, and alternator, or a motor and two couplers in series) may enhances the power output by a factor of eight. The power amplification factor depends on the size, strength, and arrangement of the permanent magnets.

Disclosed is a magnetic electrical power storage and production system that comprises an electric motor, an electrical energy generator coupled to the electric motor, and a coupling device that couples the motor to the generator. The system may be configured such that at least one of the motor, generator, or coupling device comprises a plurality of permanent magnets configured to increase an applied magnetic field to the system. The output power from the generator is greater than an input power to the motor, which may be greater than at least two times an input power to the motor. The electric motor comprises a magnetic motor, and may comprise a plurality of permanent magnets. The motor may comprise a rotor and a stator, wherein a plurality of permanent magnets is coupled to the rotor. The motor may comprise a rotating magnetic field and a static magnetic field. The coupling device may comprise a magnetic coupling and may be configured to enhance an axial torque produced from the motor. The coupling device may comprise a plurality of permanent magnets. For example, the magnets may comprise a first plurality of permanent magnets at a first radial position and a second plurality of permanent magnets at a second radial position. The coupling device may comprise a rotating magnetic field and a static magnetic field. The coupling device may couple an output shaft of the motor to an input shaft of the generator, and may be considered a spider coupling. The generator may comprises a rotor and a stator, wherein a plurality of permanent magnets is coupled to the stator. The magnets may comprise a first plurality of permanent magnets is coupled to the stator and a second plurality of permanent magnets is coupled to the rotor. The generator may comprise a rotor, a stator, and a housing at least partially surrounding an input shaft to the generator, wherein the housing comprises a plurality of permanent magnets. Each of the electrical motor, generator, and coupling device may comprise a plurality of permanent magnets.

The system comprises a plurality of battery banks coupled to the motor. A charging system may be coupled to the plurality of battery banks, wherein the charging system is configured to provide input of electrical energy to at least one of the battery banks. The charging system may be configured to generate a rate of charge greater into one of the plurality of battery banks than the rate of discharge of another one of the plurality of battery banks. The electrical energy produced from the generator may be provided to one or more external loads and at least one of the plurality of battery banks simultaneously. The plurality of battery banks may comprise a first set of battery banks and a second set of battery banks, wherein the first set of battery banks is discharged while the second set of battery banks is charged. The plurality of battery banks may comprise a first set of battery banks and a second set of battery banks, wherein the first set of battery banks is discharged to the motor while the second set of battery banks is charged by a solar assembly. The rate of charge may be greater than the rate of discharge.

The system may comprise a solar assembly, wherein the solar assembly comprises one or more solar panels. The system may also comprise a control system configured to adjust an input power provided to the motor to regulate an output power produced by the generator. The control system may also be configured to adjust an input power provided to the coupling device to regulate a torque produced by the motor. The system may also comprise a magnetic housing with a plurality of permanent magnets, wherein the magnetic housing is positioned around and external to at least one of the motor or generator, or to at least one of an output shaft to the electric motor and an input shaft to the electrical energy generator.

The coupling device may comprise a first magnetic coupling device and a second magnetic coupling device. The first magnetic coupling device may be coupled to the second magnetic coupling device in series. The first magnetic coupling device may couple an output shaft of the motor to an input shaft of the second magnetic coupling device, and the second magnetic coupling couples an output shaft of the first magnetic coupling device to an input shaft of the generator. Each of the first and second magnetic coupling devices may comprise a plurality of permanent magnets. Each of the first and second magnetic coupling devices may comprise a rotating magnetic field and a static magnetic field.

Disclosed is a magnetic electrical power storage and production system that comprises an electric motor, an electrical energy generator coupled to the electric motor, a coupling device that couples an output shaft of the motor to an input shaft of the generator, and at least one magnetic housing comprising a plurality of permanent magnets configured to increase an applied magnetic field to the system, wherein the magnetic housing is coupled to at least one of the motor or the generator. The at least one magnetic housing may be positioned around and external to the motor and/or generator. The at least one magnetic housing may comprise a first magnetic housing positioned around and external to the motor and a second magnetic housing positioned around and external to the generator. The at least one magnetic housing is coupled to an input shaft to the generator, wherein the at least one magnetic housing comprises a first plurality of permanent magnets coupled to the input shaft and a second plurality of permanent magnets that remain substantially fixed. The at least one magnetic housing may be coupled to an output shaft of the motor, wherein the at least one magnetic housing comprises a first plurality of permanent magnets coupled to the output shaft and a second plurality of permanent magnets that remain substantially fixed.

Also disclosed is a method of providing electrical energy, comprising energizing an electric motor, coupling the electric motor to a generator with a coupling device, and providing an output power from the generator that is greater than the input power to the electric motor based on an enhanced magnetic flux provided by a plurality of permanent magnets. The plurality of permanent magnets may be coupled to a rotor of the electric motor, to a stator of the generator, or located within and/or coupled to the coupling device itself. The plurality of permanent magnets may be located within a least one magnetic housing positioned around and external to at least one of the motor or the generator.

Also disclosed is a method of providing electrical energy, comprising energizing an electric motor with current from at least one of a plurality of battery banks to provide rotation of an output shaft of the electric motor, coupling an output shaft of the motor to an input shaft of a generator, generating power from the generator based on rotation of the output shaft of the motor, and providing an enhanced magnetic flux by utilizing a plurality of permanent magnets. The method may comprise utilizing one or more magnetic couplers in connection with the coupling step. The method may further comprise providing an output power from the generator that is greater than the input power to the electric motor, such as wherein the output power is greater than at least two times than the input power. The method may comprise reducing electrical power provided to the electric motor to maintain approximately the same electrical output provided by the generator. The method may comprise adjusting electrical power provided to the electric motor to maintain a desired output power provided by the generator. The method may comprise increasing an axial torque produced by the motor by utilizing a magnetic coupling device between the motor and the generator. The method may comprise increasing an axial torque produced by the motor based on the plurality of permanent magnets. The method may comprise providing a rotating magnetic field and a static magnetic field by the use of the plurality of permanent magnets. The method may comprise charging the one or more battery banks based on power provided by the generator. The method may comprise regulating the power provided to one or more external loads to maintain a predetermined battery charge threshold on the one or more battery banks. The method may comprise regulating the power provided to the electrical motor to maintain a predetermined battery charge threshold on the one or more battery banks. The method may comprise providing electrical power to a magnetic coupling device to increase an axial torque provided by the motor. The method may comprise providing electrical power to a magnetic coupling device while providing electrical power to the motor. The method may comprise reducing electrical power provided to the motor to stabilize output power from the generator. The method may comprise providing pulsating electrical power to the electrical motor to maintain system output. The method may comprise providing pulsating electrical power to the electrical motor to maintain a substantially constant output power from the generator. The method may comprise enhancing the performance characteristics of the motor or generator by applying a permanent magnetic field within the motor or generator based on the plurality of permanent magnets. The method may comprise providing electrical energy from a solar array to the one or more battery banks.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 illustrates an electrical flow diagram of one embodiment of an electrical power station of the present disclosure.

FIG. 2 illustrates an electrical flow diagram of another embodiment of an electrical power station of the present disclosure.

FIG. 3 illustrates an electrical flow diagram of another embodiment of an electrical power station of the present disclosure.

FIGS. 4A-4E illustrate an electrical flow diagram of a magnetic electrical power station of various embodiments of the present disclosure.

FIGS. 5A-5B illustrate a schematic of a magnetic electrical power station according to various embodiments of the present disclosure.

FIGS. 6A-6B illustrate a schematic of a magnetic electrical power station according to various embodiments of the present disclosure.

FIG. 7 is a schematic that illustrates magnetic housings coupled to a motor and an alternator according to one embodiment of the present disclosure.

FIG. 8 is a schematic that illustrates a magnetic housing with magnets coupled to an alternator according to one embodiment of the present disclosure.

FIG. 9 illustrates one method of operating a magnetic electrical power station according to one embodiment of the present disclosure.

FIG. 10 illustrates one method of operating a magnetic electrical power station according to another embodiment of the present disclosure.

FIGS. 11A-11D illustrate test data and parameters of a 30-hour test of a magnetic electrical power station according to one embodiment of the present disclosure.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure. The following detailed description does not limit the invention.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

### Electric Power Station

In general, the disclosed electric power station (“EPS”) uses one or more magnetic components as an integral part to the overall power production and/or distribution system. In one embodiment, the disclosed magnetic EPS may be similar to the EPS as described in U.S. Pat. No. 9,768,632 (“the '632 patent”), incorporated herein by reference, but utilizes one or more magnetic devices and/or components as an integral part to the EPS, which are not disclosed in the '632 patent. In one embodiment, any one or more of the components of the disclosed magnetic EPS (such as charging system, control system, power management system, etc.) may be substantially similar to the similarly described components in the '632 patent.

In general, the present application discloses a highly efficient regenerative hybrid power storage, generation, and management system. In one embodiment, it uses a combination of solar arrays and stored chemical potential energy (e.g., batteries) to drive one or more motors and/or electric alternators/generators. The system is a stand-alone system and may be scaled for industrial, commercial, or residential use. In one embodiment, a core concept of the EPS includes converting stored chemical energy to electrical energy, along with providing a method for storing, regenerating, and distributing this energy more efficiently, such as by using one or more magnetic devices as an integral component of the EPS. In one embodiment, the use and operation of the magnetic devices enhances the power, torque, efficiency, and/or other desired attributes/features of the EPS.

In one embodiment, electricity generated by the disclosed EPS may be utilized to directly service one or more electric loads, be transferred to the grid, and/or used to recharge the battery storage system of the EPS as needed. In one embodiment, the disclosed EPS is configured to power a wide range of devices that require electrical energy by using various mechanical and electrical principles of operation. In one embodiment, the disclosed EPS provides a regenerative energy storage and conversion apparatus and method to produce, store, and distribute electrical energy. In one embodiment, the disclosed EPS uses chemical energy to produce mechanical rotation and mechanical rotation to produce electrical energy. In one embodiment, the disclosed EPS generates and stores electrical energy as chemical potential energy in a plurality of batteries, to be transferred into mechanical energy on demand for the purpose of rotating an electrical generator to service a load and recharge the battery, and a method of production and distribution of the energy produced therefrom. In one embodiment, the disclosed EPS utilizes programmed computer controls to monitor battery charge and direct energy flow for load servicing and distribution, including a regenerative system that senses or analyzes the need for energy to supply a load.

In one embodiment, the disclosed hybrid EPS both stores potential energy in batteries and generates electricity based upon demand. The load/demand may be consistently evaluated and distributed in real time by a system computer and controls. Thus, the EPS provides an energy source that may be utilized even when no electricity is available to recharge the batteries. For example, a solar cell array may be utilized as one source to charge the batteries, but solar cells only produce electrical energy when there is sufficient sunlight. Thus, the energy generated by the EPS may be engaged when sunlight is deficient or not available. In one embodiment, a backup power source (such as electricity from the grid, a solar array, a fuel fired generator, or other conventional means) may be employed as a backup system to maintain the charge of the batteries in the event that additional power is necessary that is not supplied by the solar array system. However, in a stand-alone or solitary configuration, the backup system could be limited to a solar array as one source providing independence from the electrical distribution grid.

In one embodiment, the disclosed EPS provides an environmentally sensitive electrical power station that may be scaled to service a plurality of loads, including but not limited to industrial, commercial or residential electrical demand with the ability to grow with increased electrical demands of the business or residence with minimal or no outside power source. The EPS uses electrical current (AC or DC) from a supply battery to power an electric motor (AC or DC) that in turn engages an alternator (AC or DC) to produce electrical power distributed to a plurality of load batteries to service a load (AC or DC) and use a portion of that generated electricity to recharge the supply batteries, and a method of production and distribution of the energy produced there from.

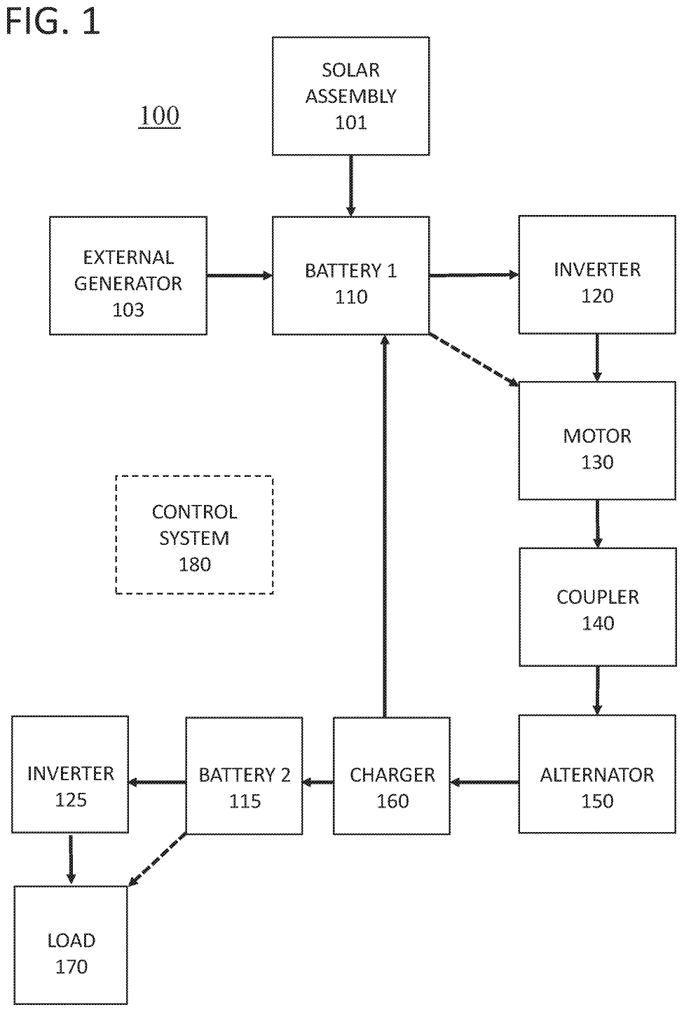

FIG. 1 illustrates one embodiment of an electric power station that may be used with a magnetic device/component. In one embodiment, this configuration is AC or DC based. In general, the EPS converts stored chemical energy (such as from a battery) into mechanical motive energy to cause rotation of an alternator to produce electricity. The disclosed EPS may comprise first battery bank 110, first inverter 120, second inverter 125, motor 130, coupler 140, alternator 150, charger 160, and second battery bank 115. Further, the EPS may comprise or be coupled to load 170. In some embodiments, solar assembly 101 may be coupled to a portion of the system, such as first battery bank 110. In some embodiments, external generator 103 is an external power supply source and may be used as a backup power source to the system and be coupled to a portion of the system, such as first battery bank 110, which may be useful if the solar array system is down or if there are long periods without power supplied from the solar array or during initial charging of the first battery system 110. The EPS may also comprise control system 180, which is electrically coupled to some or all of the components of the EPS. The control system may include a plurality of sensors, program logic controllers (PLC), one or more displays, and various other electrical components as is known in the art, and as more fully described in the '632 patent, incorporated herein by reference. For example, if pneumatic or hydraulic fluids is used as part of the EPS, the control system may include various sensors, control loops, and actuators necessary for these extra components/features.

As described in more detail, any one or more of these components may be coupled with a magnet, magnetic device, and/or magnetic system to enhance one or more desired attributes of the EPS. For example, any one of the motor, coupler, and/or alternator (or generator) may be a magnetically enhanced device as described herein. In some embodiments, the motor, coupler, and/or alternator (or generator) may be coupled to a magnetic apparatus for enhancing various operations. As is known in the art, the EPS may be AC or DC based, a dynamo may be substituted for the alternator, and the EPS may or may not use an inverter. More or less components may be used based on the particular arrangements of the system. In one embodiment, the overall size and configuration of the system is designed for a particular load and particular application.

In one embodiment, solar assembly 101 provides power to EPS 100. The solar assembly may be an off the shelf unit appropriately sized for the EPS unit. The solar assembly may include one or more solar panels (e.g., a solar array), one or more combiner panels, and one or more charge controllers, as well as other solar assembly components as is known in the art. In one embodiment, the solar array is separate from the EPS and merely provides power to the EPS, while in other embodiments the solar array is considered an integral component of the EPS. In one embodiment, the solar array provides sufficient electrical energy to the battery systems of the EPS to maintain sufficient energy storage in the batteries to optimize functioning of the electricity production circuit(s) within the EPS. In other words, the solar array is able to charge the battery system to a minimum level to keep the EPS operating at a given power output. Solar array 101 may be any conventional solar panel system and/or array (along with an inverter and any necessary circuitry as is known in the art). Solar array 101 converts sunlight to electrical energy by the use of one or more solar cells. In use, the electricity generated from the solar cells maintains sufficient electrical charge in the batteries to energize the electric energy transfer and electricity production circuit within the EPS to produce electricity for distribution. While EPS 100 may run for short or long periods of time without recharge by the solar array system, at some point if the solar array does not generate sufficient electricity (such as due to weather conditions), another means of generating sufficient electricity may be needed to maintain the charge in the battery systems to energize the electric motor. In one embodiment, a gas or liquid fueled electricity generator 103 (which is known in the art), or even electrical energy from the grid, may be utilized to maintain the electric system energy input of the EPS at required levels and/or to recharge the battery system.

In one embodiment, EPS 100 comprises first battery system 110 and second battery system 115. In one embodiment, first battery system 110 is configured to supply electrical energy to the motor (and inverter if appropriate) and is a control battery system for the EPS, while second battery system 115 is configured to supply electrical energy to one or more loads (and inverter if appropriate). In one embodiment, first battery system 110 functions as and may be referred to as the source or power batteries, and second battery system 115 functions as and may be referred to as the load batteries. The source or power batteries are the power source for the prime mover (the motor) of the EPS. In other embodiments, only a single battery system is used. For example, a battery system may be used to power the EPS while the alternator directly powers one or more loads. Each battery system may comprise a plurality of batteries connected in series or in parallel and may be considered as a group or “bank” of batteries. The number of individual batteries in each battery bank is dependent upon the load the system is designed to service, and a particular battery unit output is designed for the specific load requirements of the EPS. In one embodiment, each battery within a battery bank or battery system is charged to capacity in unison until all of the battery units are optimally charged. In one embodiment, a first battery bank system is charged at a first charging rate while a second battery bank system is charged at a second charging rate. In other embodiments, a first battery bank system is charged while a second battery bank is discharged. Such battery systems increase the electrical energy storage capacity of the EPS by chemical energy storage, thereby enabling any unused electrical energy as potential energy in reserve. The battery systems are coupled to a control system of the EPS and/or a battery management system.

In one embodiment, the batteries may be any type of rechargeable batteries such as lead-acid, nickel-cadmium (NiCd), nickel-zinc (NiZn), nickel metal hydride (NiMh), lithium-ion (Li-ion), and others, and may have wet cell or dry cell batteries. In general, the disclosed EPS and present embodiments are not limited by any particular type of battery system, and may be any off the shelf rechargeable battery. In other embodiments, the battery system may utilize supercapacitors instead of a traditional rechargeable battery. As is known in the art, supercapacitors, such as supercaps or ultracaps, are high-capacity capacitors with a capacitance value much higher than traditional batteries, can accept and deliver charge much faster than batteries, and can handle many more charging/discharging cycles than rechargeable batteries. In comparison to a traditional battery, supercapacitors charge and discharge quicker and can provide more power.

In one embodiment, two separate battery systems may be desired for the power supply and load, as they will see different charging and discharging rates and it is generally desirable to keep the battery systems separate for better power management and control of the EPS. For example, as soon as a battery is charged/discharged, there is an increase in heat for the battery system; separating different battery systems for the different charging/discharging or power supply/load requirements helps manage heat for the EPS and batteries themselves. A separate battery system also allows a charging rate of one battery system at a greater rate than a discharging rate of the other battery system, as more fully described herein and in the '632 patent. Another benefit of separating the power supplies is related to battery management. In one embodiment, the power batteries have a threshold charge under which the EPS system will shut down or start disconnecting loads. For example, normal operating ranges for the power supply may be in the order of 90-100%. If the charge of the power batteries is less than 90%, the EPS system is configured (via a control system) to reduce the discharge rate from the power supplies. This is important because in one embodiment, if the supply batteries fall below a predetermined threshold, under normal operations of power output and power input (from the solar array) the battery system can never fully recharge and there may be a slow downward cycle for the supply batteries. Eventually, once the supply batteries are down/fully discharged, the EPS system is down and cannot operate until the supply batteries are charged to a sufficient power level. On the other hand, the load batteries can be depleted more than the supply batteries. If the load batteries are down (or fall below any predetermined thresholds), the EPS can still function normally as long as the supply batteries are sufficiently charged. In one embodiment, the load batteries can drop down to 75%, 50%, or even 25% or less and the EPS unit can still work properly and still service the loads. Of course, depending on the connected loads, the power draws and duration of those loads, the EPS is designed to shut the power down to any one or more connected loads to maintain power in the load batteries or the supply batteries.

In one embodiment, supply battery system 110 is a different type of battery system than load battery system 115. In one embodiment, the source/supply batteries are slowly charged from the solar array, slowly discharged to the motor, and slowly charged from the EPS unit; in contrast, the load batteries may be quickly charged or discharged depending on the loads and the power provided from the EPS. In other words, the charging and discharging rates and capacities from the supply batteries and load batteries are different, and in one embodiment, the batteries are selected and/or configured based on these different charging capabilities. In one embodiment, the load battery is a battery configured for high charging and discharging rates, and the source/power batteries are configured for slow charging and discharging rates. In one embodiment, the load batteries may be a non-traditional battery source, such as a supercapacitor, which allows bursts of energy as needed for high load requirements.

In one embodiment, first battery system 110 is electrically coupled to an electrical conversion apparatus 120, such as an inverter, that converts DC current from the batteries to AC current for AC motor 130. In other embodiments, such as when the motor is a DC motor, an inverter may not be necessary, and power is routed directly from supply battery 110 to DC motor 130. An inverter is well known in the art, and generally is an electronic device that changes direct current (DC) to alternating current (AC), or vice versa. The input voltage, output voltage, and frequency, as well as overall power handling capabilities, depend in part on the inverter. The power inverter may be entirely electronic or may be a combination of mechanical effects (such as a rotary apparatus) and electronic circuitry. In general, there are two types of inverters—high output low frequency (HOLF) inverters and low output high frequency (LOHF) inverters. Both types are capable of operating at different frequencies, such as 50 and 60 Hz frequencies. Inverters may convert energy from DC to AC or AC to DC, and may convert the electrical energy to a wide range of frequencies. In one embodiment, inverter 120 converts 360 volt DC to three-phrase 380 volt AC. In other embodiments, the inverter converts 200 to 450 volt DC to three phase AC. In one embodiment, the inverter is a 3 phase inverter, may use a modified wave form, and/or may be a variable frequency drive (VFD) inverter that controls AC motor speed and torque by varying the motor input frequency and voltage.

Inverter 120 may be electrically coupled to motor 130, which may be coupled to alternator 150 by coupler 140. In one embodiment, motor 130 is a conventional electric motor with an output shaft, and alternator 150 is a conventional alternator with an input shaft. As is known in the art, a motor is an electrical device that converts electrical energy into mechanical energy, and generally reverse to a motor, a generator (such as an alternator or DC generator/dynamo) is an electrical device that converts mechanical energy into electrical energy. Coupler 140 may be a mechanical coupling (such as a spider coupling) that transfers the mechanical energy from the motor to the alternator. The mechanical coupling may be a conventional coupling as is known in the art or a high efficiency, high strength, light weight alloy or polymer based coupling system. In other embodiments, any one of the motor, coupler, or alternator may comprise or be coupled to a permanent magnetic device or system, as detailed further herein. As is known in the art, the motor and alternator are sized/configured to produce a certain amount or torque, power, or RPM. The motor and alternator are sized appropriately based on the load requirements of the EPS and the intended use/application. In one embodiment, the coupler is an assisting component of the EPS, and is used in the transfer of rotation/torque between the motor to the alternator. In one embodiment, each of the motor, inverter, and alternator is 3 phase, which is configured to produce 3 phase AC by the EPS, while in other embodiments the system is configured to produce single phase AC power. In one embodiment, the motor is the “prime mover” of the EPS system and not the “alternator” or the “coupler,” while in other embodiments the collection of the motor, coupler, and alternator may be considered as the “prime mover” for the EPS. Inverter 125 may be substantially similar to inverter 120. Inverter 125 is illustrated in FIG. 1 as connecting battery system 115 to load 170, which assumes that load 170 is an AC based load. In the event that load 170 is a DC based load, inverter 125 may not be needed and power may flow directly from battery system 115 to load 170.

In one embodiment, motor 130 is an electric motor or device that converts electrical energy into mechanical energy. Motor 130 may be a DC motor or an AC motor. As is known in the art, a DC motor may receive power from a DC battery source without an inverter, while an AC motor requires an inverter to utilize power from a DC battery source. In one embodiment, the motor is a 3 phase asynchronous induction motor, while in other embodiments it is a brushless DC motor. Electric motor 130 may produce linear force or rotary force. In one embodiment, the electric motor uses a magnetic field and winding currents to generate force. As is known in the art, the electric motor may have a rotor and a stator. The rotor is the moving part of the motor that generally turns the shaft of the motor to produce mechanical power. The rotor may have permanent magnets or have conductors/windings that carry current. The stator is the stationary part of the motor and usually consists of either coiled windings or permanent magnets. The motor may be synchronous or asynchronous, and DC or AC based. If the motor is a brushless DC motor, then no inverter is necessary between the battery system and the motor. In one embodiment, the motor is sized based on the size of the EPS system, and in particular the targeted output horsepower, torque, or load of the EPS. In one embodiment, a brushed DC motor has an average efficiency value between 70-85%.

In one embodiment, the alternator is an electrical generator that converts mechanical energy to electrical energy in the form of alternating current. A generator, for the purposes of this disclosure, may include an alternator (which produces AC power) or a DC generator/dynamo (which produces DC power). Thus, while one may loosely consider the described alternator as a generator (which is generally known as a device that converts motive power into electrical power for use in an external circuit), the overall EPS system itself should more properly be considered as a generator (which includes both a motor and an alternator/generator). Conventional alternators have a rotor and a stator, and a rotating magnetic field in the rotor causes an induced AC voltage in the stator windings. In general, there are two primary ways to produce a magnetic field in an alternator. First, permanent magnets may be used which create their own persistent magnetic fields—these types of alternators may be called magnetos. Second, wound electric coils may be used to form an electromagnet to produce the rotating magnetic field. In some embodiments, a dynamo (DC based) is used instead of an alternator (AC based); as is known in the art, a DC based alternator is generally known as a dynamo, and an AC based alternator is simply an alternator. The benefits of the disclosed EPS does not depend on whether an alternator is DC based or AC based, or whether an alternator is used instead of a dynamo (which is generally considered to be an “alternator” as described herein). In one embodiment, the alternator is a 3 phase alternator, and may be a 3 phase permanent magnet alternator or generator (PMG/PMA).

Alternator 150 may be electrically coupled to charger/charging system 160 and/or load 170. Charger 160 is electrically coupled to one or more of the battery banks. For example, FIG. 1 illustrates charger 160 being electrically coupled to first battery system 110 and second battery system 115. EPS 100 is configured to not only charge the battery systems but to also provide electric energy to one or more loads. In some embodiments, the batteries are charged without supplying electrical energy to the loads, while in other embodiments electrical energy is provided to the load without electrical energy being provided to the batteries. In another embodiment, first battery system 110 is being charged while second battery system 115 is being discharged, while in another embodiment first battery system 110 is being charged while second battery system 115 is not being charged or discharged. In some embodiments, as more fully described in U.S. Pat. No. 9,768,632, incorporated herein by reference, the charger is configured to generate a rate of charge to one battery bank faster (such as battery bank 110) than a rate of discharge of another battery bank (such as battery bank 115).

Load 170 may comprise one or more internal or external loads. The load may be internal or external to the EPS. The load may be part of the EPS (such as a charger or other internal load) or merely coupled to the EPS. In one embodiment, a load of the EPS may be considered the charging system. In most applications, the load is an external load, such as any industrial, commercial, or residential load. In one embodiment, the electrical energy produced by the EPS may be distributed to load 170 for temporary or sustained usage via load battery system 115 to inverter 125 (if load is AC based) then to load 170. In one embodiment the EPS can functional normally and/or in normal operation without having a load connected. In other embodiments, the EPS can selectively turn on and off different loads that are connected to the EPS to maintain the desired battery levels of the system and other operating parameters, such as output power, voltage, or frequency. In one embodiment the EPS may operate in an energy conserving status or a battery recharging status such that the supply battery system 110 is recharged by directing most of the power produced from alternator 150 to battery system 110.

Control system 180 is electrically coupled to one or more of the components within EPS 100. The charging system of EPS 100 (as well as other components within EPS 100) is controlled by control system 180. In one embodiment, portions of control system 180 are electrically coupled to each of the components within EPS 100, and is used to regulate the production, management, and distribution of electrical energy within the EPS and to one or more of the connected loads. In one embodiment, the control system comprises one or more control units, sensors, and a plurality of inputs and outputs electrically connected to each of the EPS electronic components. In one embodiment, the control system manages the battery power within the EPS by controlling the charging and discharging of the battery banks via electronic instruction by using a series of mechanical and electronic devices to analyze, optimize, and perform power production, load servicing, and charging functions in sequence to achieve the particular goals/attributes of the EPS. In one embodiment, the control system manages the charge of battery system 110 (the supply battery system) by controlling the output power provided by the EPS and/or the loads serviced by the EPS. In one embodiment, the control system manages the input current/power provided by battery system 110 to motor 130 to achieve the desired output power provided by alternator 150.

As is known in the art, the control system may comprise one or more programmable logic controllers (PLCs). In general, a PLC is a known control device used in industrial control applications that employs the necessary hardware architecture of a computer and a relay ladder diagram language. It may be a programmable microprocessor-based device that is generally used in manufacturing to control assembly lines and machinery as well as many other types of mechanical, electrical, and electronic equipment. PLCs may be programmed in a variety of computer languages, and in one embodiment may be programmed in an IEC 61131 language. The PLCs and other components of the control system have been programmed by methods known in the art to enable individual control of each of the components in the EPS during normal operation.

The control system may further comprise programmed instruction with computerized control by known methods, including but not limited to a programmed logic controller (PLC), a personal computer, or commands transmitted through a network interface. Any control units of the control system may monitor the EPS system parameters such as voltage, current, temperature, rotational speed, vibration, frequency battery charge, load demand, alternator output, motor output, electrical energy inputs and outputs, etc., by receiving data from a plurality of sensors including but not limited to temperature sensors, current sensors, electricity demand sensors, and electrical charge-discharge sensors. The control system is configured to interpret or analyze the data according to programmed instructions/protocols and output necessary commands. In one embodiment, any received data input is processed in a control unit of the control system according to programming or command instructions, and instructions will be electronically output to a plurality of electrical switches and electrical valves within the control system and EPS to maintain system electricity generation and energy storage as required.

In one embodiment, when the control system signals a release of electrical energy, the electrical energy flows through an electrical supply line to a PLC/PC logic controller according to system electric demand. An electrical controller directs current flow through one or more of a plurality of electrically connected electrical control lines, which may be connected to motor 130. Electrical energy passing through an electric rotary motor 130 will cause the motor to rotate its output shaft which is in turn connected to a coupling 140 which is in turn connected to the input shaft of a specific alternator 150 designed to output a specific amount of electrical current. The alternator 150 may also be electrically connected (via charger 160) to specific battery storage units 110, 115. In one embodiment, current outflow from alternator 150 is directed into respective return electrical lines electrically connected to battery banks 110, 115 to complete the electrical circuit and return the electrical current back to the battery bank(s) for reuse. Thus, the control system is configured to monitor and control the battery systems and output from the alternator for optimal power distribution and battery recharging. This control feature permits disengagement of alternator 150 or diversion of the alternator output to assist in charging a battery unit.

In operation, electric motor 130 withdraws power from battery system 110 (which may or may not be regulated by inverter 120), which causes an output shaft of electric motor 130 to rotate. Thus, electrical energy is converted to mechanical energy. An input shaft of the coupled alternator 150 is rotated by direct mechanical connection to the output shaft of the motor via coupler 140. The alternator is energized to generate a specific output of electrical energy based on the design requirements and intended use/application of the EPS. Thus, mechanical energy is converted to electrical energy. The electrical energy produced by rotation of alternator 150 is directed to charging system 160. Thus, the mechanical energy from electric motor 130 is transferred to the electrical energy generator (alternator 150) to produce electrical energy for distribution and use by the EPS.

In one embodiment, the disclosed EPS may be scaled to fit large or small load demands. In one embodiment, the motor is similarly sized to the alternator. For larger load demands, a plurality of permanent magnet couplers may be utilized in series (which create an enhanced power amplification factor for the particular EPS), or a plurality of EPS systems may be combined to service a single load.

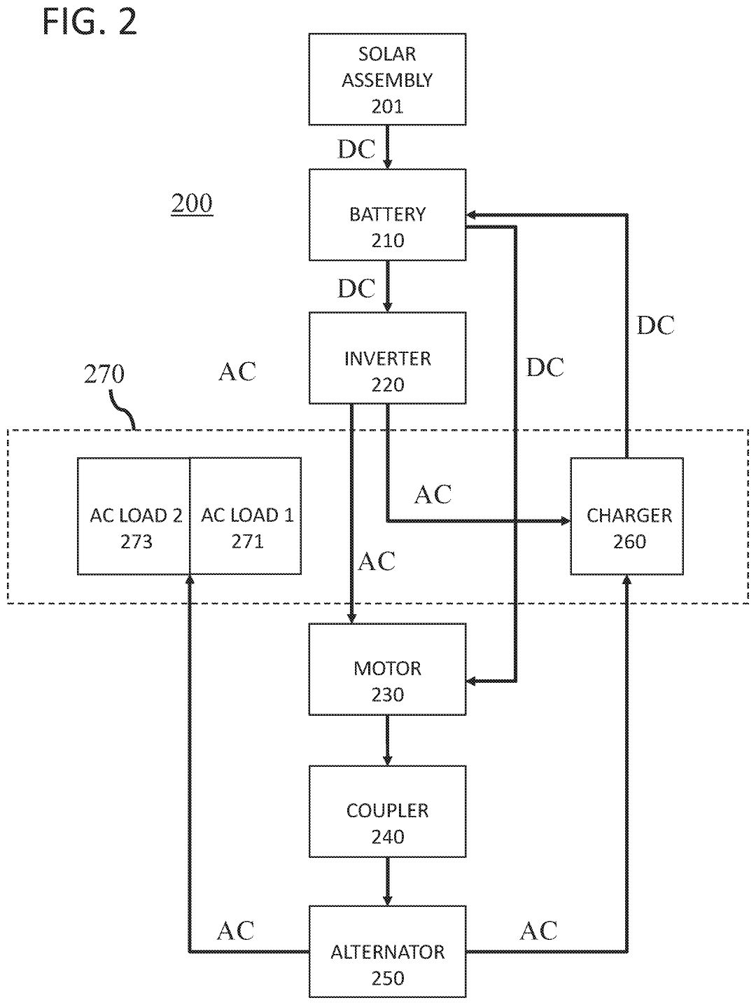

FIG. 2 illustrates another embodiment of an electric power station that may be used with a magnetic device/component. FIG. 2 illustrates a system substantially similar to that described in FIG. 1 and similarly converts stored chemical energy (such as from a battery system) into mechanical motive energy to cause rotation of an alternator to produce electricity. While the system illustrated in FIG. 1 may be AC or DC based, in one embodiment the system illustrated in FIG. 2 is AC based. In other words, the prime mover (the motor) of system 200 is AC based (or DC based in some embodiments), while the secondary/production system may be AC based. Further, FIG. 2 only illustrates a single battery system as opposed to a dual battery system (power supply and load supply) as shown in FIG. 1.

In one embodiment, EPS 200 comprises battery system 210, inverter 220, motor 230, coupler 240, alternator 250, and charger 260. EPS 200 may also be coupled to solar assembly 201 and a plurality of loads 271, 273. In one embodiment, EPS 200 provides energy to a plurality of internal and external loads 270 (indicated by dashed box in FIG. 2). For example, first load 271 and second load 273 may be external loads to the EPS, while charging system 260 may be considered an internal load. In various embodiments, a first load may be AC based and a second load may be DC based, or all loads may be AC or DC based. FIG. 2 shows both external loads as AC based. In some embodiments, an external generator (such as generator 103, not shown in FIG. 2) may be used as a backup power source to the system in addition to solar array 201. While not shown, EPS 200 also comprises a control system connected to each of the electronic components of the system, such as that illustrated and described in relation to control system 180 in FIG. 1. Also, an inverter may not be necessary based on the type of motor used in the EPS. For example, if the motor is a DC based brushless motor, then power may be supplied directly from battery system 210 to motor 230 without the need for an inverter. Because the charger and loads are AC based in FIG. 2, an inverter is not needed to provide power from the alternator to the loads; however, if the alternator is a dynamo (DC based) or if the loads are DC based, then an inverter (not shown) would be necessary. More or less components may be used based on the particular arrangements of the system.

In general, the components described in FIG. 2 operate substantially similar to those same components described in relation to FIG. 1. Electrical energy from battery system 210 is provided to inverter 220. That electrical energy may be provided to motor 230 (if it is AC based) and subsequently to alternator 250 via coupler 240. In another embodiment, if the motor is DC based, energy is provided directly to the motor from the battery without passing through the inverter. Energy provided from alternator 250 (AC based) may be directly provided to any one or more of the AC loads (such as load 271 or load 273) or charging system 260. In other embodiments, charger 260 is directly provided electrical energy from inverter 220. As described herein in more detail, any one or more of these components may be coupled with a permanent magnet, magnetic device, and/or magnetic system to enhance one or more desired attributes of the EPS. For example, any one of the motor, coupler, and/or alternator may be a magnetic device and/or coupled to a magnetic device for enhancing various operations of the EPS. Coupler 240 may be a mechanical coupler and/or a magnetic coupling. In the embodiment illustrated in FIG. 2, the motor may be AC or DC based and the alternator is an AC based device. If the motor is DC based, power is directly routed to it from the battery; if the motor is AC based, power is routed first through an inverter. In one embodiment, alternator 250 is configured to produce 1 or 3 phase AC power, and charger 260 is configured to produce 1 or 3 phase AC or DC power. In one embodiment, system 200 may only have a supply battery system and not a separate load battery system as described in FIG. 1. In this embodiment, the control system needs to be configured to appropriately control the power output from the alternator directly to the loads, with any excess power routed to the charging system.

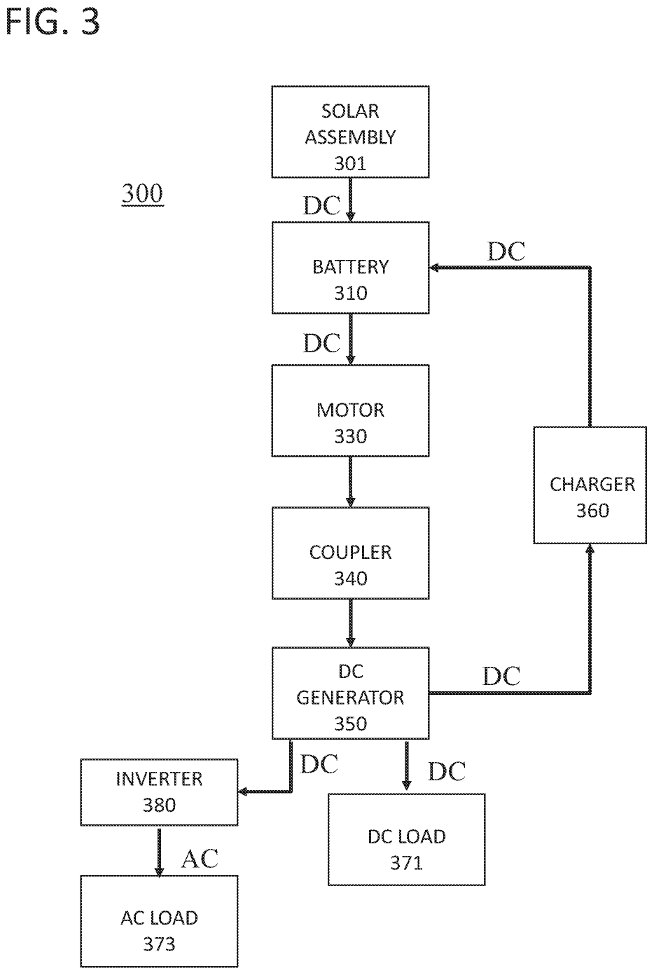

FIG. 3 illustrates another embodiment of an electric power station that may be used with a magnetic device/component. While the system illustrated in FIG. 1 may be AC or DC based, in one embodiment the system illustrated in FIG. 3 shows a DC based system (not an AC based system) with a DC generator 350. In other words, the prime mover (the motor) of system 300 is DC based and the secondary/production system (generator) is also DC based. FIG. 3 illustrates a system substantially similar to that described in FIGS. 1 and 2 and similarly converts stored chemical energy (such as from a battery) into mechanical motive energy to cause rotation of an alternator (or DC generator as illustrated in FIG. 3) to produce electricity. In one embodiment, EPS 300 comprises battery system 310, motor 330, coupler 340, generator 350, and charger 360. Similar to FIG. 2, system 300 only has a primary or supply battery system that powers the prime mover (e.g., the motor), and there is no separate load battery and instead the DC generator directly powers the DC load. EPS 300 may also be coupled to solar assembly 301 and be coupled to one or more loads 371, 373. In this embodiment, load 371 is a DC load and is provided power directly from DC generator 350, while load 373 is an AC load that requires DC power from the DC generator to be routed through an inverter 380. In this embodiment, electric motor 330 is a DC motor that does not require an inverter as it runs on DC supplied from battery 310. In this embodiment, alternator is a DC based generator (e.g., a dynamo), and produces DC power for DC load 371. In one embodiment, the electrical energy provided from DC generator 350 is supplied to charger 360 (for charging battery system 310) and load 370. The electrical energy provided to each connected device varies based on the need of the load and/or battery system and the output of the generator, all of which is managed by a control system. In one embodiment, generator 350 is configured to produce 1 or 3 phase DC power, and charger 360 is configured to produce 1 or 3 phase DC power. As is known in the art, charger 360 may be a DC/DC converter with a step up or a step down for the voltage. In other words, the charging system is able to regulate the voltage from the DC generator to provide the correct voltage for the battery system. In some embodiments, charger 360 may not be necessary if the DC generator output voltage may be the same as the voltage for the batteries. For example, if the battery voltage is 48V, and the DC generator provides an output of 48 V, then no charging system may be necessary; however, if the DC generator provides an output of 120V, then a step down charging system would be necessary. While not shown, EPS 300 also comprises a control system connected to each of the electronic components of the system, such as that illustrated and described in relation to control system 180 in FIG. 1. Coupler 340 may be a mechanical coupler and/or a magnetic coupling. Generator 350 may be a DC based generator that produces direct current, such as a dynamo, as opposed to an alternator. As is known in the art, an electric dynamo uses rotating coils of wire and magnetic fields to convert mechanical rotation into a pulsing direct electric current through induction. More or less components may be used based on the particular arrangements of the system.

### Magnetic Electric Power Station (MEPS)

In the prior art, if a battery is used to supply a load, there would be no reasonable reason to include additional devices between the battery and the load (such as a motor, coupler, alternator, etc.) as those additional devices inherently create energy loss, heat, and are otherwise inefficient. In other words, the most simple and efficient mechanism to supply a load (using a solar array) is seemingly to connect the solar array to the battery and to supply the load with the battery based on the electrical energy supply within the battery as provided by the solar array. In other words, increasing components of an EPS necessarily creates inefficiency and loss, and thus there needs to be a significant reason to use additional devices that provides additional benefits to the overall EPS.

The disclosed EPS utilizes specific components with permanent magnets that provide for increased torque, decreased power usage, and/or amplified power output to further increase the outputted power or torque based on the same amount of input, or similarly, to produce the same amount of power or torque based on a decreased power input. In one embodiment, the use of one or more magnetically enhanced devices significantly increases various benefits of the MEPS, including the ability to produce increased torque and/or increased RPM at the same electrical input, the ability to operate the motor and/or alternator at higher rates/RPMs based on the same or less electrical input, and/or the ability to generate a certain amount of power based on less input energy. In one embodiment, these added benefits overcome any negative side effects such as heat loss, device inefficiencies, etc. based on the increased number of system components.

In one embodiment, the combination of a motor and alternator/generator may be referred to loosely as a “genset,” otherwise known as an engine/generator. As is known in the art, a “genset” generically refers to a set of separate devices or equipment that is combined together into a single “device” that is used to convert mechanical energy into electrical energy. For example, a conventional engine-generator or portable generator is the combination of an electrical generator and an engine (prime mover) mounted together to form a single piece of equipment; this combination is also called an engine-generator set or a gen-set. For the purposes of this disclosure, a genset includes a motor and an alternator/generator, and may include (but does not necessarily include) a coupling device between the motor and the alternator/generator.

In one embodiment, the use of specially arranged permanent magnets in each of the motor, coupler, and/or generator increases the magnetic field over each of the devices and varies different attributes of the torque, rotation, etc. of the EPS. While electricity may be provided to the particular magnetically enhanced device (e.g., an active magnetic device), in some embodiments the magnetic device may simply comprise a plurality of magnets without requiring additional energy (e.g., a passive magnetic device).

For the purposes of this disclosure, a magnetically enhanced device is a novel device and is not merely a device that utilizes a magnetic field as conventionally performed in the prior art. As is known in the art, conventional motors and alternators typically use some type of magnetic field for their normal operation. A typical motor may have a rotor and a stator with one or more electric coils in the stator to create an induced magnetic field in the rotor; however, a conventional motor does not utilize permanent magnets within the rotor. Likewise, a typical alternator may have a rotor with magnets that create an induced magnetic field in the stator; however, a conventional alternator does not utilize permanent magnets within the stator. In one embodiment, the disclosed MEPS uses a typical motor and/or a typical alternator with a magnetic coupling device, whereas in other embodiments the disclosed MEPS uses a novel magnetically enhanced motor and/or a magnetically enhanced alternator. For this disclosure, a “magnetic motor,” a “magnetic coupler,” and a “magnetic alternator” (or “magnetic generator”) have special meanings.

In one embodiment, a “magnetic motor” as described herein is an electric motor that includes a stator and a rotor and a plurality of permanent magnets coupled to the rotor. In operation, the magnetic field of the motor is increased because of the static magnetic field of the permanent magnets on the rotor and the induced magnetic field of the stator by application of a (small) induced current into one or more coils within the stator and surrounding the rotor. The overall magnetic field is an enhanced magnetic field that combines a magnetic field of the rotor (B1) and the induced magnetic field of the stator (B2), which overall increases the torque/power output from the motor as compared to a conventional motor. Similar to a conventional motor, together, the rotor and stator produce a rotary force output from the motor based on supplied electrical energy to the stator. In contrast to prior art motors, the disclosed magnetic motor comprises a plurality of permanent magnets coupled to the rotor.

In one embodiment, a “magnetic coupler” as described herein is a mechanical coupler between two devices that comprises a plurality of permanent magnets. In one embodiment, the magnetic coupling device couples the prime mover (motor) to the alternator/DC generator, while in other embodiments it may be considered as a secondary prime mover as it helps and/or increases the torque provided by the motor to the alternator/DC generator. The magnetic coupler comprises permanent magnets that may be positioned on either (i) a rotor (e.g., the magnets may be coupled to one or more rotatable shafts within the magnetic coupling device, thereby rotating with the rotatable shafts) or on (ii) a rotor (rotating magnets) and a stator (stationary magnets) within the magnetic housing. In addition, the magnetic coupler may partially or entirely surround the output shaft of a motor and/or the input shaft of the alternator. In a first operation, a magnetic field is created based on a (small) induced current into one or more coils surrounding the rotor with permanent magnets (creating magnetic field B1); the induced rotating magnetic field of the magnetic coupler increases the torque/power output from the magnetic coupler. In a second operation, a magnetic field is present based on the first plurality of permanent magnets within the rotor (B1 magnetic field) and the second plurality of permanent magnets (B2 magnetic field) within the housing/stator; based on the rotation of the inner magnets coupled to the shaft, which is coupled to the motor output shaft, the rotating inherent magnetic field of the magnetic coupler increases the torque/power output from the magnetic coupler. Thus, as compared to a conventional spider coupling, the described magnetic coupling increases the produced torque/power based on the inherent magnetic field of the permanent magnets.

In one embodiment, a “magnetic generator” (or “magnetic alternator”) as described herein is an alternator or generator that includes a plurality of permanent magnets on both the rotor and the stator of the generator. In operation, the overall magnetic field of the generator/alternator is increased because of the static magnetic field of the permanent magnets on the outer shell of the stator. The overall magnetic field is an enhanced magnetic field that combines a magnetic field of the rotor (B1) and a magnetic field of the stator (B2), which overall increases the torque/power output from the motor as compared to a conventional generator (which may only have permanent magnets coupled to a rotor and not the stator). In effect, the generator is able to vary a magnetic field from static to kinetic to amplify the power output based on given mechanical movement. Similar to a conventional alternator, together, the rotor and stator convert a rotary force input into electrical energy. In contrast to prior art alternators/generators, the disclosed magnetic alternator comprises a plurality of magnets coupled to the stator and/or part of a housing that surrounds the rotor and/or rotating input shaft of the alternator.

In one embodiment, a prior art device may utilize a solar source connected to a battery that powers a load (which may include an inverter). In this embodiment, as just one example, the electrical transfer may be 1:1:1, minus any power losses and efficiencies. In the disclosed embodiment, it may utilize a solar source connected to a battery supply connected to the magnetic electric power station that powers a load (which may include one or more inverters). In one embodiment of the present disclosure, the electrical transfer may be in the order of 1:2:1 or 1:3:1 or 1:4:1, minus power losses/efficiencies, which accounts for the use of magnetic components in the motor, coupler, or alternator, which provides for a Power Amplification Factor (PAF) that is greater than traditional power supply devices. In other words, while the disclosed electric power stations introduces additional components to a power supply system, the use of permanent magnets allows a PAF to the overall system of 2-5× a traditional system. In one embodiment, based on a given power input from the solar array, the power output of the EPS may be 2-5× the power input. In one embodiment, the use of a magnetic motor as disclosed herein reduces the power input needed to provide the same torque, and thus acts as a power reducing component. In one embodiment, the use of a magnetic coupler as disclosed herein increases the power produced from the motor, and thus acts as a power multiplying factor. In one embodiment, the use of a magnetic alternator as disclosed herein increases the power produced from the motor, and thus acts as a power multiplying factor. In one embodiment, the overall efficiencies of a prior art power supply system may be approximately 50-80% efficient, while in one embodiment the efficiency of the disclosed EPS may be approximately 96% efficient.

In one embodiment, the use of a static and applied/variable magnetic field may be applied to one or more components of an EPS to produce the desired enhanced benefits. In one embodiment, the use of a single magnetic device increases the desired affect (such as torque) by a predetermined amount, such as 2 times. In one embodiment, the use of two magnetic devices increases the desired affect (such as torque) by a predetermined amount, such as 4 times. In one embodiment, the use of three magnetic devices increases the desired affect (such as torque) by a predetermined amount, such as 8 times.

Table I (below) illustrates exemplary power enhancement factors of a MEPS unit that contains one or more components that utilize permanent magnets as described herein. For illustration purposes, the MEPS unit is divided into three general categories: motor, coupler, and alternator/generator. Eight types or configurations of MEPS gensets are provided in the below table, with various “factors” provided for each device of the genset. A “traditional” motor, coupler, or alternator/generator would not increase the power (and is therefore given a value of 1), while a “magnetic” device is assumed to increase the power output (or reduce the required electrical input) by a factor of 2. Of course, these factors are for illustration purposes only and the actual enhancement based on the magnetic device will depend on the particular components utilized and the configuration and arrangement of the magnets. Type A illustrates a conventional genset with no magnetic devices. Types B and C illustrate use of a single magnetic device (magnetic coupler and magnetic motor, respectively) for an overall power multiplier of two. Types D, E, and F illustrate use of two magnetic devices (D—magnetic coupler and magnetic motor; E—magnetic motor and magnetic alternator; F—two magnetic couplers in series) for an overall power multiplier of four. Types G and H illustrate use of three magnetic devices (G—magnetic motor and two magnetic couplers in series; H—magnetic motor, magnetic coupler, magnetic alternator) for an overall power multiplier of eight. Type I illustrates use of three magnetic devices (magnetic coupler, magnetic motor, and magnetic alternator) for an overall power multiplier of 4.5, with different assumptions that the coupler and generator produce only 1.5 times power output instead of 2 times power output.

| | | | | POWER |
|---|---|---|---|---|
| | | COU- | ALTERNATOR/ | AMPLIFICATION |
| TYPE | MOTOR | PLER | GENERATOR | FACTOR (PAF) |
| A | 1 | 1 | 1 | 1 |
| B | 1 | 2 | 1 | 2 |
| C | 1/2 | 1 | 1 | 2 |
| D | 1/2 | 2 | 1 | 4 |
| E | 1 | 2 | 2 | 4 |
| F | 1 | 2:2 | 1 | 4 |
| G | 1/2 | 2:2 | 1 | 8 |
| H | 1/2 | 2 | 2 | 8 |
| I | 1/2 | 1.5 | 1.5 | 4.5 |

As shown above, utilizing any one or more of the above MEPS configurations, a variety of PAF values may be obtained. For comparison purposes, a conventional generator configuration (Type A) may require an electrical motor/system input of 20 hp to produce 15 hp of mechanical output (based on efficiencies). In other words, a typical power generating device require more electrical input than the output produced based on system heat loss and other typical inefficiencies. In a first embodiment of the present disclosure, which may utilize a Type B or Type C configuration, a MEPS system may require only 10 hp of electrical input to produce a mechanical output of 20 hp. In other words, the electrical input power is approximately ½ (10 hp instead of 20 hp)—corresponding to a PAF of 2—as compared to a conventional system. As another embodiment, which may utilize a Type D or Type F configuration, a MEPS system may require only 5 hp of electrical input to produce a mechanical output of 20 hp. In other words, the electrical input power is approximately ¼ (5 hp instead of 20 hp)—corresponding to a PAF of 4—as compared to a conventional system. Of course, other PAF factors and system variations are possible to one of skill in the art based on the teachings in this disclosure.

The magnets may be neodymium magnets, which are permanent magnets made from an alloy of neodymium (Nd), iron (Fe), and boron (B). In general, neodymium magnets are graded according to their maximum energy product, which relates to the magnetic flux output per unit volume. Higher values indicate stronger magnets, and may range from N35 up to N54 or greater. In one embodiment, the disclosed magnets are solid core neodymium magnets ranging from N38 to N52.

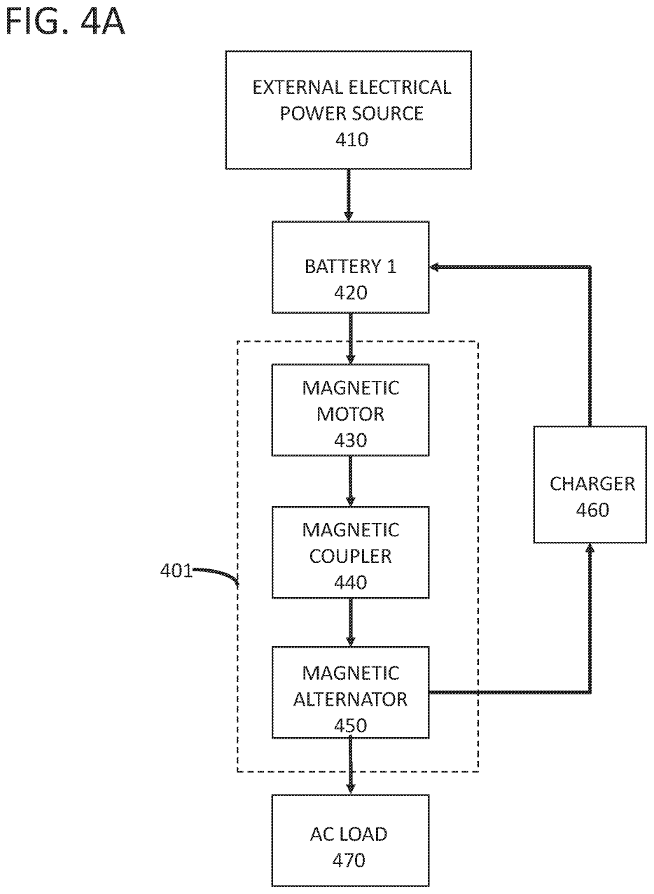

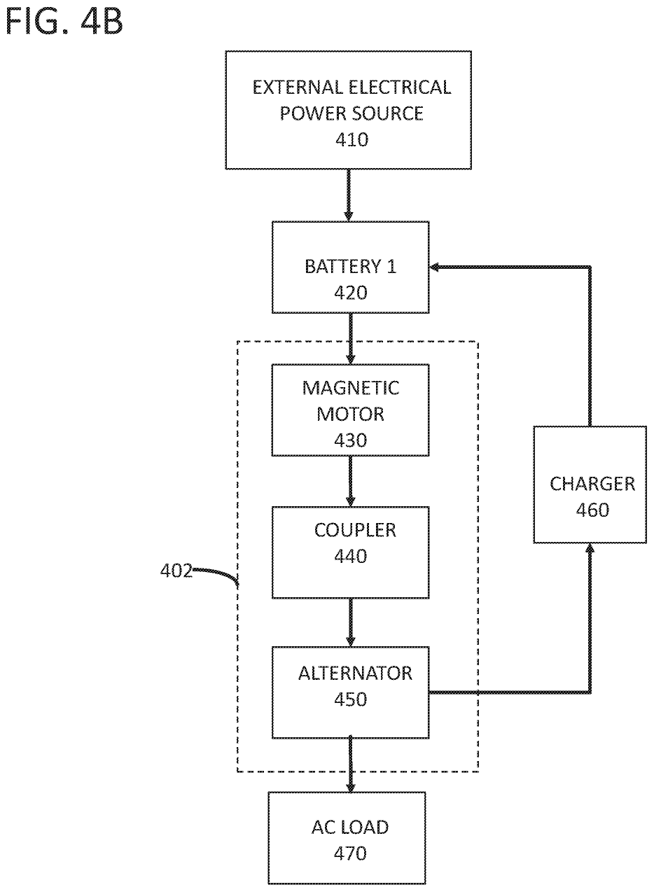

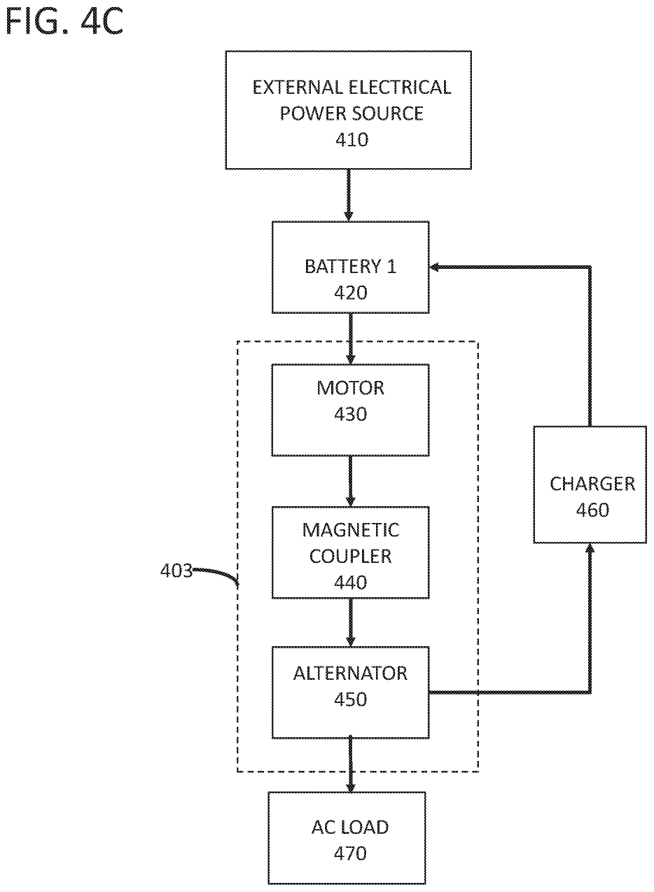

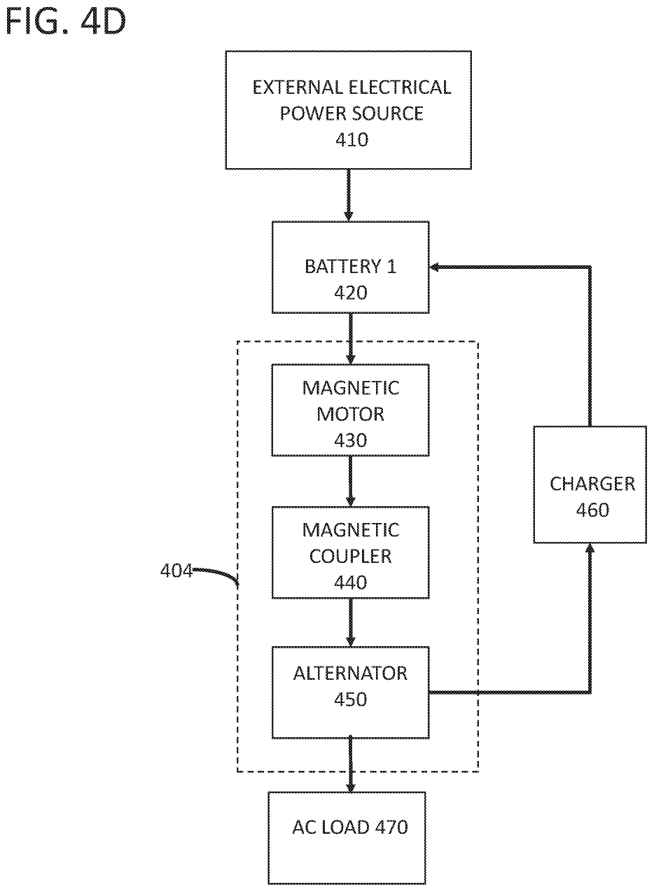

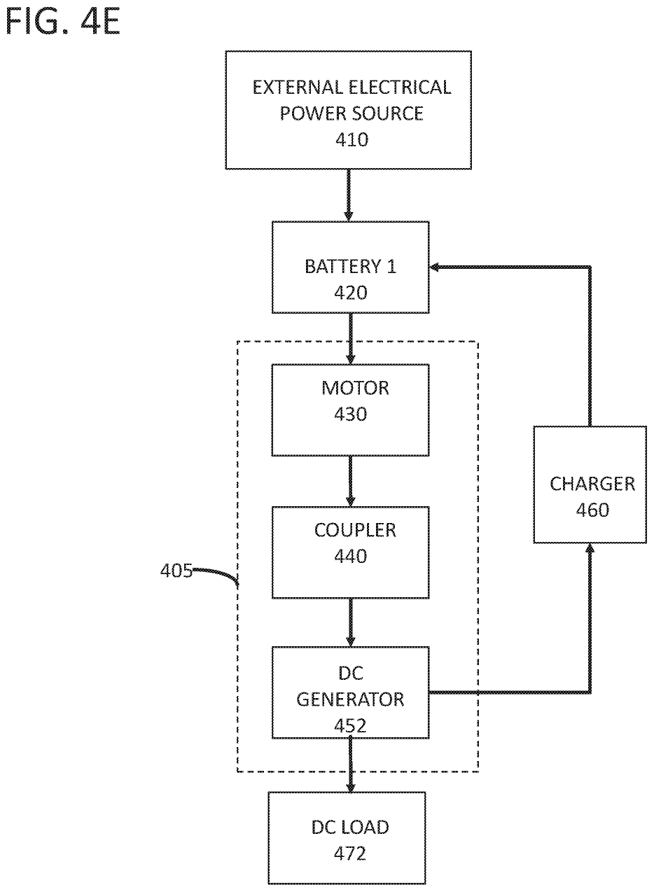

FIGS. 4A-4E illustrate various embodiments of an electrical flow diagram of a magnetic electrical power station (“MEPS”) according to the present disclosure. FIGS. 4A-4E illustrate a system substantially similar to that described in FIGS. 1-3 and similarly converts stored chemical energy (such as from a battery) into mechanical motive energy to cause rotation of an alternator or generator to produce electricity to one or more loads and to simultaneously recharge the battery system. In some embodiments, output power from a generator may not need to be re-routed from the generator to the supply batteries if the input power from the external power source is sufficient to offset any discharge of the batteries to provide the necessary power output of the system. In other words, if the loads are small enough, re-routing of the generator power to re-charge the battery systems may not be needed. One or more of the motor, coupler, or alternator/generator may be a magnetically enhanced device as described herein.

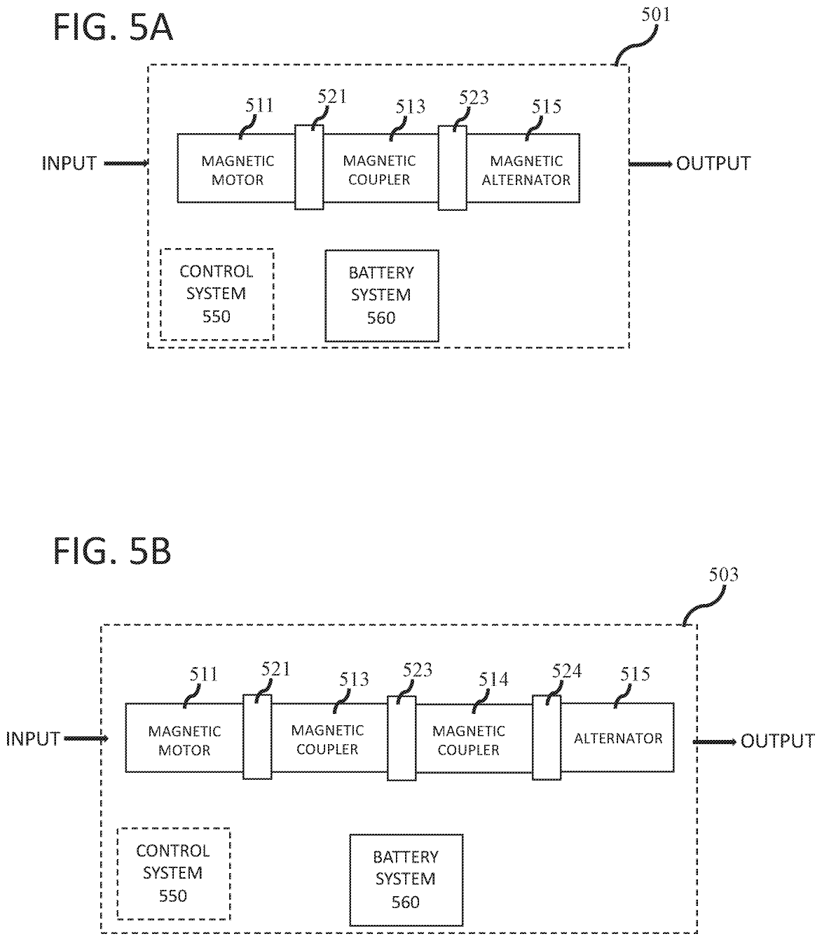

Referring to FIGS. 4A-4E, a magnetic EPS (“MEPS”) is illustrated that includes battery system 420 (i.e., source/supply batteries), motor 430, coupler 440, alternator/generator 450, and charger 460. The EPS may comprise and/or be coupled to external electrical power source 410 (such as a solar assembly array) and one or more loads 470. This system may be AC based (which would require one or more inverters as is known in the art, such as that illustrated in FIGS. 1 and 2) or may be DC based, in which inverters would not be needed (such as illustrated in FIG. 3). The alternator may be an AC based alternator (which would need an inverter if the load is DC based) or a DC based generator (which would need an inverter if the load is AC based). In one embodiment, the motor, coupler, and alternator of the system is considered a separate unit, as illustrated by the dashed boxed around the collective units. For the MEPS unit, one or more of the MEPS components magnifies the power of the system; in other words, the power input to motor 430 from the source battery system 420 is magnified as an output from alternator/generator 450. In one embodiment, the described MEPS includes any one of the motor, coupler, or alternator as having a magnetically enhanced device. In other embodiments, two of the devices may comprise magnetically enhanced devices (such as motor and coupler, motor and alternator, or coupler and alternator). In still another embodiment, all three of the devices (motor, coupler, and alternator) may comprise a magnetically enhanced device. In still another embodiment, a plurality of magnetically enhanced couplers may be utilized in series between the motor and the alternator (see, e.g., FIG. 5B) to provide an even greater power amplification factor for the MEPS system. The individual components illustrated in FIGS. 4A-4E are substantially similar to those described in FIGS. 1-3. Each MEPS requires a control system (such as control system 180) as described herein. FIGS. 4A-4D illustrate an AC based alternator that supplies an AC load, while FIG. 4E illustrates a DC generator that supplies a DC load.

FIG. 4A shows a MEPS embodiment where each of the motor, coupler, and generator is a magnetically enhanced device. For example, motor 430 is a magnetic motor, coupler 440 is a magnetic coupler, and alternator 450 is a magnetic alternator (or magnetic generator), together which form genset 401. In this embodiment, the overall system has three enhanced magnetic devices. Assuming that each device produces either 2× electrical power output or ½ electrical power input, then the overall power amplification effects would be approximately eight (8) times, based on three separate magnetic devices.

FIG. 4B shows a MEPS embodiment where the motor is a magnetically enhanced motor, while the coupler is a traditional mechanical coupler (without any magnetic enhancements) and the alternator is a traditional alternator. For example, motor 430 is a magnetic motor, coupler 440 is a traditional coupler, and alternator 450 is a traditional alternator (or generator), together which form genset 402. In this embodiment, the overall system has only one enhanced magnetic device. Assuming that the device requires ½ electrical power input, then the overall power amplification effects would be approximately two (2) times, based on a single magnetic device.

FIG. 4C shows a MEPS embodiment with a magnetically enhanced coupler, while the motor is a traditional motor (without any magnetic enhancements) and the alternator is a traditional alternator. For example, motor 430 is a traditional motor, coupler 440 is a magnetic coupler, and alternator 450 is a traditional alternator (or generator), together which form genset 403. In this embodiment, the overall system has only one enhanced magnetic device. Assuming that the device produces 2× power output, then the overall power amplification effects would be approximately two (2) times, based on a single magnetic device.

FIG. 4D shows a MEPS embodiment where the motor is a magnetically enhanced motor and the coupler is a magnetically enhanced coupler, while the alternator is a traditional alternator. For example, motor 430 is a magnetic motor, coupler 440 is a magnetic coupler, and alternator 450 is a traditional alternator (or generator), together which form genset 404. In this embodiment, the overall system has two enhanced magnetic devices. Assuming that each device produces either 2× power output or requires ½ electrical power input, then the overall power amplification effects would be approximately four (4) times, based on two magnetic devices.

FIG. 4E shows a MEPS embodiment where any one or more of the motor, coupler, or DC generator may be a magnetically enhanced device, while the remaining device(s) may be a conventional device. As compared to FIGS. 4A-4D, this system has a DC generator 452 (instead of AC alternator 450), and directly services DC load 472 (instead of AC load 470). Of course, the electrical flow is the same as prior FIGS. 4A-4D. For example, motor 430 may be a magnetic motor or a traditional motor, coupler 440 may be a magnetic coupler or a traditional spider coupling, and generator 452 may a magnetic generator or a traditional generator, together which form genset 405. In one embodiment, the overall system has one, two, or three enhanced magnetic devices. Assuming that each device produces either 2× electrical power output or requires ½ electrical power input, then the overall power amplification effects would be two, four, or eight times, based on whether one, two, or three separate magnetic devices are utilized.

FIGS. 5A-5B illustrate a schematic of a magnetic electrical power station according to various embodiments of the present disclosure. FIGS. 5A and 5B illustrate a similar arrangement as described throughout this disclosure in that a motor is coupled to an alternator (or generator) by a coupling device. The primary difference between FIGS. 5A and 5B is that FIG. 5A utilizes a single magnetic coupling device while FIG. 5B utilizes two magnetic coupling devices in series. In one embodiment, an output shaft of the electrical motor is coupled to an input shaft of the alternator/generator. Electrical input power is provided to this system and electrical output is produced from this system. In one embodiment, the electrical input provided to the system is less than the electrical output produced from the system. In one embodiment, the electrical output from the system is greater than at least two times, three times, or more than five times the electrical input to the system. For the motor, in one embodiment, the use of permanent magnets reduces the electrical input needed to the motor to produce the same mechanical output, or conversely, increases the mechanical output from the motor based on the same electrical input. For the alternator/generator, in one embodiment, the use of permanent magnets amplifies the produced electrical output based on the provided mechanical input. For the coupler, in one embodiment, the use of permanent magnets multiples the axial torque from the motor and/or the encapsulated shafts. FIG. 5A illustrates genset 501 that comprises magnetic motor 511, magnetic coupler 513, and magnetic alternator/generator 515. One or more physical couplings 521, 523 or flanges may or may not be needed between the difference devices. As described herein, the system may require control system 550 and battery system 560. Similarly, FIG. 5B illustrates genset 503 that comprises magnetic motor 511, first magnetic coupler 513, second magnetic coupler 515, and alternator/generator 515. As compared to FIG. 5A, system 503 includes an additional magnetic coupler (two couplers are now in series) and a traditional alternator instead of a magnetic alternator. One or more physical couplings 521, 523, 524 or flanges may or may not be needed between the difference devices.

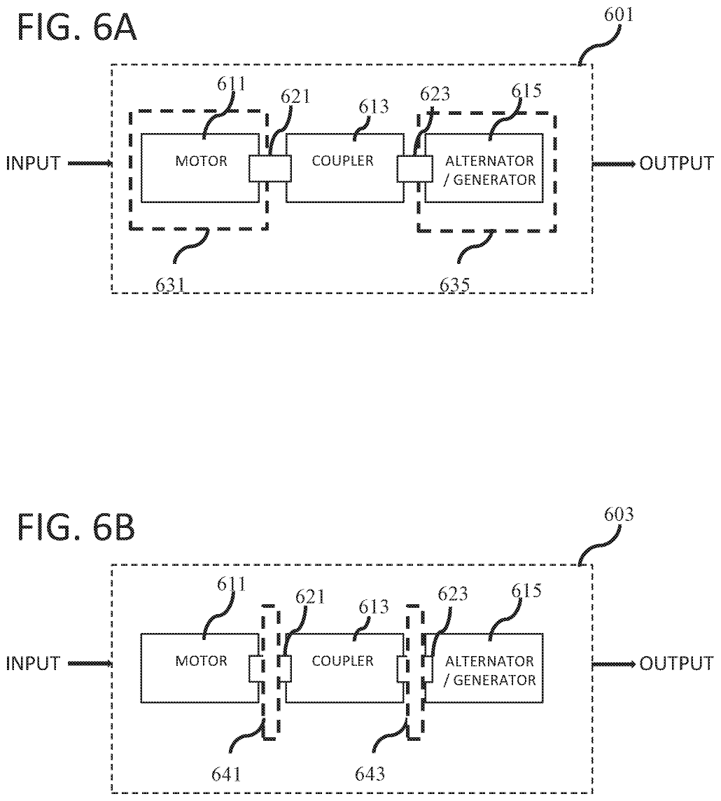

FIGS. 6A-6B illustrate schematics of a magnetic electrical power station (MEPS) according to various embodiments of the present disclosure that utilizes an external magnetic housing over one or more of the MEPS components. FIGS. 6A and 6B illustrate a similar arrangement as described throughout this disclosure in that a motor 611 is coupled to an alternator (or generator) 615 by coupling device 613. In one embodiment, output shaft 621 of the electrical motor 611 is coupled to input shaft 623 of the alternator/generator by coupler 613. Electrical input power is provided to this system and electrical output is produced from this system. In one embodiment, the electrical input provided to the system is less than the electrical output produced from the system. In one embodiment, the external magnetic housing enhances the magnetic flux over the applied device. The size, quantity, strength, and positioning of permanent magnets within the housing itself, relative to each other, and relative to the encapsulated device depends on numerous factors.

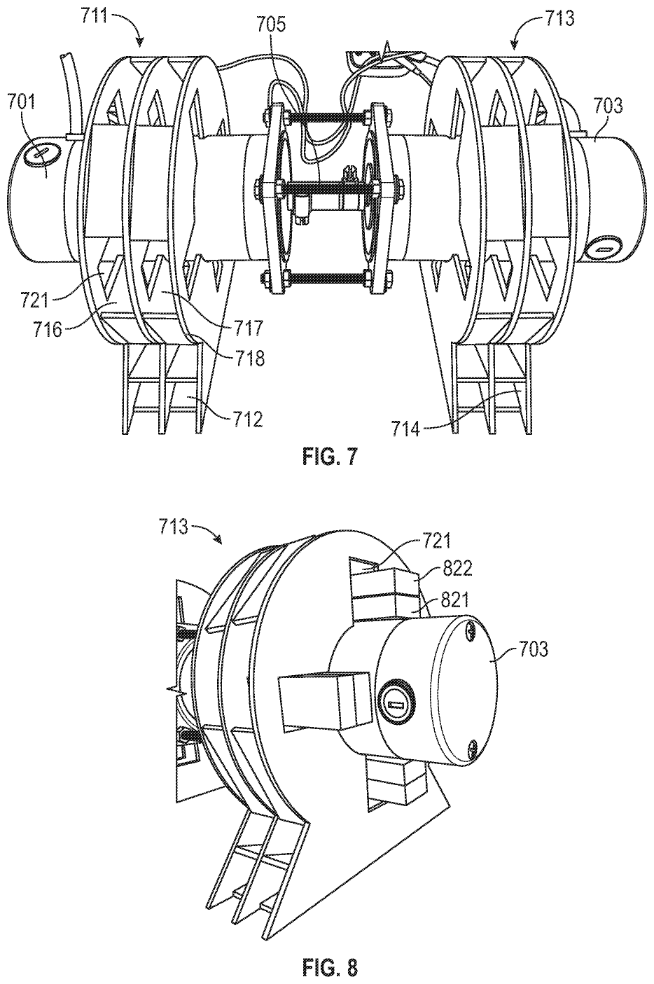

FIG. 6A illustrates genset 601 that comprises motor 611, coupling device 613, and alternator/generator 615, with a first magnetic housing 631 that is external to and/or partially surrounding to motor 611, and a second magnetic housing 635 that is external to and/or partially surrounding to alternator/generator 615. In one embodiment, the magnetic housings 631, 635 comprises a plurality of permanent magnets that are used to enhance a magnetic field over the encapsulated device (whether it is the motor or alternator/generator). The magnets can be arranged radially or in various disk configurations, and there may be multiple layers or rows of magnets at different radial positions within the housing, and there may be multiple sets of magnets positioned axially (or longitudinally) along the motor/alternator. Thus, magnets can be arranged within the housing at various and multiple axial and/or radial positions within the housing. The housing may comprise any generally non-conductive material that can securely hold the magnets in position relative to each other and to the encapsulated device. The permanent magnets may be positioned as close as possible to the motor and/or generator/alternator such that the magnetic flux from the permanent magnets affects the enclosed device. For example, the magnets may be positioned within 0.1 to 1 mm of the motor or generator/alternator. In one embodiment, the magnets are glued or otherwise securely fastened to an inner surface of the external housing; in other embodiments, the magnets may be directly coupled to the motor housing or alternator housing itself. In one embodiment, the motor or alternator/generator may have a second plurality of permanent magnets disposed within the device itself (for example, the motor itself may have permanent magnets coupled to the rotor such as described herein). For the motor, in one embodiment, the magnetic housing reduces the electrical input needed to the motor to produce the same mechanical output, or conversely, increases the mechanical output from the motor based on the same electrical input. For the alternator/generator, in one embodiment, the magnetic housing amplifies the produced electrical output based on the provided mechanical input. In one embodiment, the magnetic flux for the motor is the magnetic flux of the magnetic housing in summation to any induced magnetic field applied by the energizing current to the motor. In one embodiment, the magnetic flux for the alternator/generator is the magnetic flux of the magnetic housing in summation to any induced magnetic field caused by rotation of the alternator shaft. In other embodiments, only one of the motor or alternator/generator may have an external magnetic housing. In other embodiments, an external magnetic housing may also partially surround coupling device 613. One schematic of such an embodiment is illustrated in FIGS. 7 and 8.

FIG. 6B illustrates genset 603 that comprises motor 611, coupling device 613, and alternator/generator 615, with a first magnetic housing 641 that is external to and/or partially surrounding output shaft 621 of motor 611, and a second magnetic housing 643 that is external to and/or partially surrounding input shaft 623 of alternator/generator 615. In one embodiment, the magnetic housings 641, 643 comprises a plurality of permanent magnets that are used to enhance a magnetic field over the encapsulated device (e.g., shaft). The magnets can be arranged radially or in various disk configurations. The magnets can be arranged radially or in various disk configurations, and there may be multiple layers or rows of magnets at different radial positions within the housing, and there may be multiple sets of magnets positioned axially (or longitudinally) within the housing. Thus, magnets can be arranged within the housing at various and multiple axial and/or radial positions within the housing. The housing may comprise any generally non-conductive material that can securely hold the magnets in position relative to each other and to the rotating shaft. In one embodiment, the permanent magnets may be positioned as close as possible to the encapsulated rotating shaft such that the magnetic flux from the permanent magnets affects the shaft. For example, the magnets may be positioned within 0.1 to 1 mm of the shaft (or to any magnets directly coupled to the shaft). In one embodiment, the external housing comprises a first plurality of permanent magnets, and a portion of the shaft enclosed by the housing may have a second plurality of permanent magnets, such that the first plurality of magnets is affected by and/or interacts with the second plurality of permanent magnets. The distance between the first and second plurality of magnets may be between 0.1 mm to 1.0 mm, as just one embodiment, but the distance depends in part on the relative strengths of the magnets. In one embodiment, the first layer of magnets are included within a ring that is pressed or slid around the shaft. The magnets may fit within a groove or other machined opening of the ring, or may simply be glued together or directly coupled to the shaft and surrounded by a relatively thin (and non-conductive) outer sheathing, such as plastic. In one embodiment, the inner or first layer of magnets rotate with the rotating shaft, while the second or outer layer of magnets remain substantially fixed in position within the housing. In one embodiment, the second layer of magnets are glued or otherwise securely fastened to an inner surface of the external housing. The permanent magnets within the magnetic housings (and that are coupled to the shaft) effectively increase the magnetic flux of the shaft to increase the output power based on the same amount of input power. In one embodiment, the magnetic flux is the magnetic flux of the permanent magnets within the magnetic housing in summation to the magnetic flux of the permanent magnets coupled to the shaft (which is also surrounded by the magnetic housing). In one embodiment, only the output shaft from the motor may include an external magnetic housing, while in other embodiments only the input shaft to the generator/alternator may include an external magnetic housing. In other embodiments, an external magnetic housing may also partially surround coupling device 613, such that it at least partially surrounds shafts 621, 623.

FIG. 7 is a schematic that illustrates magnetic housings coupled to a motor and an alternator according to one embodiment of the present disclosure, which may be substantially similar to the schematic embodiment illustrated in FIG. 6A. FIG. 7 illustrates motor 701 coupled to alternator 703 via a direct mechanical coupler 705. External housing 711 is positioned around motor 701 and external housing 713 is positioned around alternator 703. Each of the housings may have a base support 712, 714, respectively, to hold the housing in place. Each housing has a plurality of sections 716, 717, 718 in which magnets may be positioned radially or axially around the motor or alternator. While there are no magnets positioned within the external housings shown in FIG. 7, each housing has cutouts 721 in which permanent magnets may be placed. For example, each housing has three cylindrical wafers or sections 716, 717, 718 in which four rectangular cutouts 721 are spaced at opposing radial positions. In one embodiment, a magnet may be positioned within a cutout extending across all three wafers, as shown in FIG. 8.

FIG. 8 is a schematic that illustrates a magnetic housing with magnets coupled to an alternator according to one embodiment of the present disclosure. In one embodiment, FIG. 8 shows magnets positioned within alternator housing 713 of FIG. 7. While the described housing is for an alternator, a similar housing may be positioned around the motor. FIG. 8 illustrates magnetic housing 713 that partially surrounds an alternator (or motor) 703. Within the housing is located a plurality of permanent magnets (such as neodymium magnets) that are spaced radially around alternator 703 at four different concentric positions within cutouts 721 (see FIG. 7). In one embodiment, a second layer of magnets is positioned at a further radial position then the first layer of magnets. For example, a first layer of magnets 821 may be positioned directly on the alternator housing 703 and a second layer of magnets 822 may be positioned directly on the first layer of magnets. In one embodiment, the magnetic housing 713 comprises three sections (which may be circular wafers) with cutouts in which are positioned the rectangular permanent magnets 821, 822 that extend throughout the plurality of sections. In other embodiments, separate magnets may be positioned within each section or portion of the housing. The permanent magnets are positioned precisely around alternator 703 (or motor) to provide an enhanced magnetic flux to the components within the alternator/motor and, consistent with the teachings in the present disclosure, enhance the electrical or mechanical output of the particular device based on the same amount of input energy.

### Operation/Use

The versatility of the disclosed MEPS allows it to be utilized in a wide variety of operations. For example, it can be used in industrial, commercial, and/or residential applications. It may be used to apply a continuous load as a standalone power station or may be used in electrical stations or systems to provide standby or enhanced power management capabilities. It may be paired with any external power source (such as gas or diesel generators, solar, coal, the grid, etc.), and is not limited exclusively to input from solar panel assemblies. Other forms of alternative energy inputs may likewise be utilized within the scope of the disclosure. The MEPS unit may be used in series or in parallel, and may be used to service small or large loads.

In one embodiment, a method of power generation is disclosed that utilizes one or more magnetically enhanced devices as part of an energy generating electrical power station. In one embodiment, the method may comprise providing power to a motor from a battery system, converting electrical energy into mechanical energy via the motor, transferring mechanical energy from the motor to an alternator/generator, and converting mechanical energy into electrical energy via the alternator/generator. The method may further include servicing one or more loads from the produced electrical energy and/or charging one or more battery systems from the produced electrical energy. The method may include providing a passive magnetic field to the motor by the use of permanent magnets coupled to the motor, such as the rotor. The method may include providing a passive magnetic field to the generator by the use of permanent magnets coupled to the generator, such as within the stator and/or an additional housing around the input shaft. The method may include providing a passive magnetic field to the output shaft of the motor, the input shaft of the alternator, and/or a direct mechanical coupling between these shafts by the use of a magnetic coupler.

In some embodiments, multiple magnetic devices may be used simultaneously to create further magnetic enhancements to the EPS. In one embodiment, the control system for the MEPS is configured to vary and/or modify the applied magnetic fields from each of the magnetic motor, magnetic alternator, and magnetic coupler to produce the desired system output at any particular moment in time, whether it is used for charging the batteries or for servicing an electric load. Thus, the method may further include monitoring any one or more of the applied magnetic fields as well as RPMs and torque of the shaft(s) and varying the magnetic field(s) to produce the desired result(s). In some embodiments, the use of a magnetic device (such as a coupler) enhances the power output by a factor of 2, while the use of two magnetic devices (such as a coupler and a motor, or two couplers in series) enhances the power output by a factor of 4, while the use of three magnetic devices (such as a coupler, motor, and alternator, or a motor and two couplers in series) may enhances the power output by a factor of eight. Of course, the power amplification factor depends on the size, strength, and arrangement of the permanent magnets.

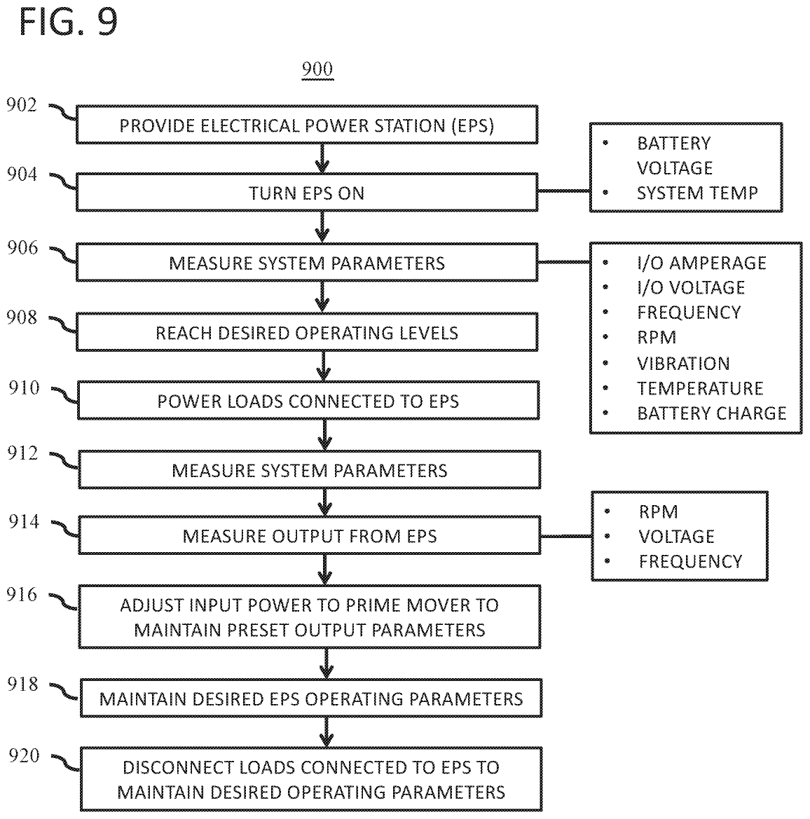

FIG. 9 illustrates one method of operating a magnetic electrical power station according to one embodiment of the present disclosure. In one embodiment, method 900 includes step 902 directed to providing and/or utilizing an electrical power station (EPS), as described herein. In one embodiment, the EPS may comprise a motor and alternator/generator, and may also include a battery system, a charging system, a control system, and coupling device between the motor and alternator/generator. In one embodiment the EPS may be coupled to one or more electrical power input systems, such as a solar assembly, and may service one or more external loads. The EPS may be AC or DC or AC/DC based. In one embodiment, one or more of the motor, coupler, and alternator/generator may include permanent magnets and be a magnetically enhanced device as generally described herein. Thus, in one embodiment the EPS is a magnetic EPS (MEPS) as described herein.

Step 904 may comprise turning the EPS on. In one embodiment, the voltage of the batteries is measured and the temperature of the system is measured. If the battery voltage is at a sufficient level (such as greater than a 75% charge or 90% charge), and the temperature of the EPS (whether the battery system or any of the components within the EPS) is at a sufficient temperature (e.g., not too hot), then the EPS may be turned on. At this point, no loads are directly connected and the system is effectively performing an initialization process. In one embodiment, current is provided to the motor, which rotates an output shaft, which through one or more direct or indirect couplings rotates an input shaft of an alternator/generator, which produces electrical power.

Step 906 may comprise measuring various system parameters based on sensors positioned throughout the system. For example, the input and output power to the system may be measured, and the input power to each device (motor, coupler, generator, charging system, batteries, etc.) may likewise be measured. Other parameters such as amperage, voltage, frequency (Hz), RPM, vibration, and temperature may be measured at each point within the EPS, and the charge of each battery and battery bank may be monitored continually. In one embodiment, the system parameters are continuously measured during the duration of operating the EPS unit. As is known in the art, a PLC unit may be integrally coupled to a plurality of sensors within the system for constant measuring capabilities.

Step 908 may comprise reaching desired operating levels. In other words, once the system has turned on and the individual components have started operating, at some point the initialization process ends and the normal operating mode turns on. This step may include maintaining a substantially stable and/or continuous output voltage, power, RPM, and/or frequency, which may be measured as the output from the generator. For example, in one embodiment a power output of 15 kva may be desired at a frequency of 60 Hz and a voltage of 220 V. The system runs for a certain amount of time until that desired output is reached and maintained for a predetermined amount of time. In one embodiment, the input and/or output of each of the magnetic motor, magnetic coupler(s), and magnetic generator affects each other, so the system may take some amount of time to reach stabilization. For example, as the output shaft from the motor turns, this increases the magnetic field applied by a magnetic coupler (which is coupled to the output shaft of the motor), which in turn amplifies the torque produced from the coupler and the reduces the power necessary at the motor to produce the desired mechanical output. This is a dynamic process that may require variation of each of the electrical inputs to reach a substantially continuous and stable operating output. This step may include varying the input to the motor or the coupler to reach the desired output from the generator. In one embodiment, power is varied to the motor while the power provided to the coupler (if it is a magnetic coupler as described herein) is kept substantially constant. In one embodiment, it takes approximately 5-10 seconds for the system to reach a stabilized mode after being turned on. In other embodiments, it may take 30 seconds or more, such as 1 to 5 minutes. The goal for this step is to reach steady state and/or normal stabilized output.

Step 910 may comprise powering external loads connected to the EPS. If multiple loads are coupled to the EPS, a load may be powered up one at a time, or multiple loads may be powered simultaneously. In one embodiment, a PLC is utilized with input terminals and output terminals to automatically power the connected loads. Step 912 may comprise measuring the system parameters after powering on one or more external loads, which may be substantially similar to the measuring steps performed in step 906. Step 914 may comprise measuring the power output from the EPS unit after the loads are being powered, such as at the generator and/or that is being used to service the loads. This may include measuring the RPM, voltage, and/or frequency of the system output. In one embodiment, the output from the system is greater than the input to the system.

Step 916 may include adjusting the input electrical power to the prime mover of the EPS to maintain the present output parameters. In one embodiment the prime mover is the electric motor of the system. Based on various loads powered by the system, the system may need to increase the power to the genset unit (the motor, coupler, alternator) to produce a higher electrical output produced; in other situations, to minimize the power consumption on the battery levels, the power input may need to be decreased if the load is not that significant. In one embodiment (particularly with a large load), to keep the RPM constant at the output the electrical power provided to the motor needs to be increased or decreased, depending on the load demands. Likewise, to produce more torque the RPM may need to be increased for the system. In one embodiment, continuous current at a constant voltage may be supplied to the motor, while in other embodiments continuous current at varying voltages may be supplied to the motor. In some embodiments, pulsating current at a constant voltage may be supplied to the motor, while in other embodiments pulsating current with varying voltages may be supplied to the motor. In other words, if only a given amount of power is needed to maintain the desired output power parameters, then only the minimally necessary power is provided to the motor to provide that power.

Step 918 may comprise maintaining the desired EPS operating parameters, which may include voltage, RPM, and/or frequency. In other embodiments, it may include any of the system parameters mentioned in relation to step 906, including battery charge. As mentioned in step 916, this may be performed by adjusting the input electrical power to the prime mover of the EPS to maintain the present output parameters. In other embodiments, input power may be adjusted to the magnetic coupler to vary the torque produced from the coupler.

Step 920 may include disconnecting one or more loads that are connected to the EPS to maintain the desired operating parameters. For example, if there are four loads connected to the EPS and a single load is significantly greater than the others and is causing issues for the EPS unit, then that single load may be automatically disconnected and allow the system to reach the desired operating parameters, such as frequency, RPM, voltage, power, or battery charge, among others. In one embodiment, all of the loads may be disconnected if the battery charge reaches a minimum operating threshold, such as a 75% or 90% charge level. In this instance, the loads are disconnected until a sufficient battery charge is reached, which will maintain operation of the EPS unit, and then the loads may be automatically re-powered similar to the above steps 906-920. In one embodiment, method 900 may utilize a power management system and/or method to conserve the battery charge within the battery system, as well as various charging and discharging methods as more fully described in the '632 patent, incorporated herein by reference.

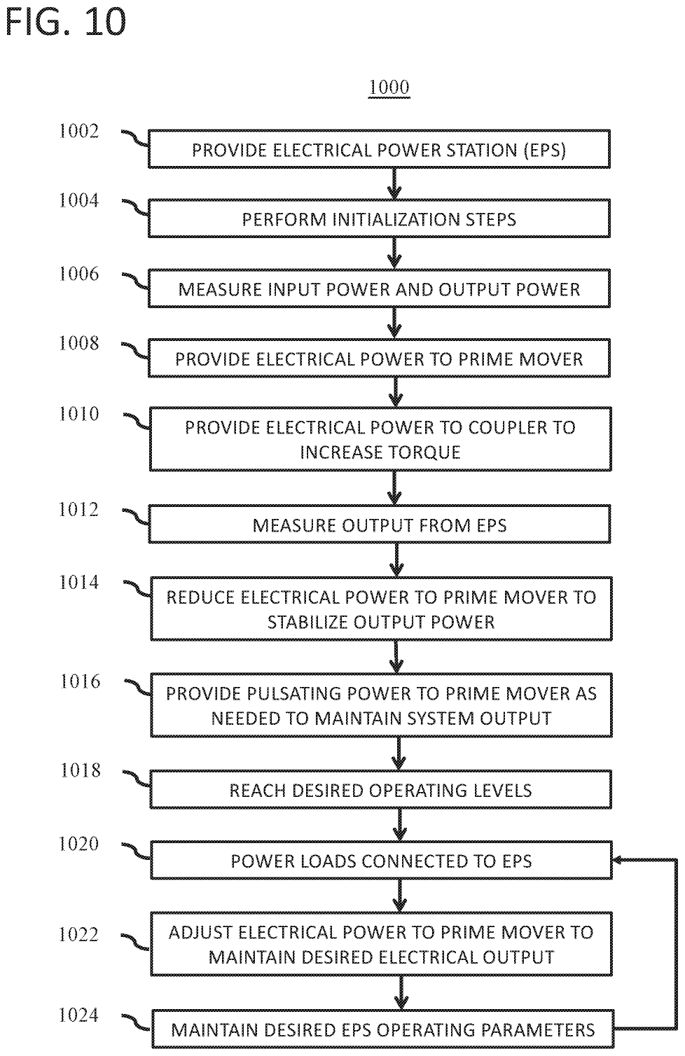

FIG. 10 illustrates one method of operating a magnetic electrical power station (MEPS) according to one embodiment of the present disclosure. In one embodiment, it is similar to the steps described in FIG. 9. In one embodiment, method 1000 includes step 1002 directed to providing and/or utilizing an electrical power station (EPS), as described herein. In one embodiment, the EPS may comprise a motor and alternator/generator, and may also include a battery system, a charging system, a control system, and coupling device between the motor and alternator/generator. In one embodiment the EPS may be coupled to one or more electrical power input systems, such as a solar assembly, and may service one or more external loads. The EPS may be AC or DC or AC/DC based. In one embodiment, one or more of the motor, coupler, and alternator/generator may include permanent magnets and be a magnetically enhanced device as generally described herein. Thus, in one embodiment the EPS is a magnetic EPS as described herein.

Step 1004 may include performing various initialization steps. For example, as in steps 904 and 906 in relation to FIG. 9, the EPS unit may be turned on and various system parameters measured. In one embodiment it includes providing electrical power to the prime mover (motor) to get the system started. Step 1006 may include measuring the input power and/or output power of the system. If the output is not consistent and/or if it is not at the desired operating levels of the EPS for the intended load, the input power to various components may need to be adjusted to reach the desired operating level. In one embodiment, the method may include providing electrical power to a prime mover (the motor) as in step 1008. In one embodiment, the method may include step 1010 of providing electrical power to the coupler (if it is a magnetic coupler as described herein) to increase the torque applied to the system. If the EPS utilizes a traditional coupler (such as a spider coupling), then this step may be omitted. In one embodiment, providing power to the motor affects the torque (and magnetic flux) provided to the coupler, and the power applied to the coupler affects the power necessary for the motor, and thus a loop is created between the power to the coupler and the motor that may require varying the power to each unit until the system reaches the desired operating levels. In one embodiment, if a magnetic coupler is utilized, it may take many seconds (such as 5-10 seconds) or even longer for the coupler to get “on-line” with the rotating and static magnetic fields of the coupler and to start helping the power output from the motor.

Step 1012 includes measuring the system parameters and/or output from the EPS, which may be similar to steps 912 and 914. In one embodiment, the RPM, voltage, and/or frequency is measured as output from the EPS (such as the output from the alternator/generator). Based on the use of the magnetic devices within the EPS as described herein, power may be reduced to the system and still maintain the same output. Step 1014 may comprise reducing the electrical power to the prime mover (motor) to stabilize the output power. In one embodiment, if the coupler is a magnetic coupler, the power provided to the magnetic coupler is relatively small and may be substantially constant while the power to the motor is increased and/or varied. In one embodiment, the pulsating power is provided only after the magnetic coupler is on-line and assisting the motor. In one embodiment, the ability to pulsate (and the strength and frequency of the pulses) depends on the load. Step 1016 may comprise providing pulsating power to the prime mover as needed to maintain the system output. Because of the permanent magnets utilized within the system (such as the magnetic coupling device and/or the motor), in one embodiment the system acts similar to the momentum created by a swing. To keep a child swinging, only a periodic or push is needed at the height of the swing loop to maintain the child swinging at a desired rate and height. Similarly, once the system achieves steady state and/or normal operation, the permanent magnets creates a dynamic system that allows only pulsating current to be provided to the motor to create the same output. This achieves significant power savings based on a significant decrease in the input necessary to the motor, and of course saves the battery levels within the battery system. In one embodiment, the pulsating current remains the same. In other embodiments, the pulsating current may have a variable voltage based on the loads. In one embodiment, a pulse occurs for each rotation. For example, if the motor is operating at 1500 RPM, then there will be approximately 25 pulses per second to the motor (1500/60). If the motor is operating at 1800 RPM, then there will be approximately 30 pulses per second (1800/60). More or less pulses may be needed.

After the power is provided and/or varied to the electrical motor and torque converter, at some point the EPS unit will reach steady state operation and achieve the desired operating levels, such as shown in step 1018. Once the system reaches steady state operating levels, loads may be connected to the system and powered as illustrated in step 1020, which may be substantially similar to step 910. Based on the size and duration of the loads, the EPS system may need to be varied to provide a constant output for the connected loads. In one embodiment, the electrical input power to the prime mover is varied/adjusted as necessary to maintain the desired output parameters and/or desired electrical output, as illustrated in step 1022. This may include varying the power provided to the motor (whether continuous current/pulsating current or constant voltage/varying voltage) to adjust the mechanical output from the motor. In one embodiment, the larger the load, the greater the electrical input to the motor. In one embodiment, greater electrical input to the motor produces greater mechanical output to the alternator, which then produces greater electrical output based on the greater mechanical input and an overall increased power output to service the larger loads. Step 1024 may comprise maintaining the desired EPS operating parameters, which may include voltage, RPM, and/or frequency, and may be similar to step 918. In other embodiments, it may include any of the system parameters mentioned in relation to step 906, including battery charge. As the loads are connected or disconnected to the EPS, the electrical power to the prime mover is varied to achieve the desired output.

### Testing

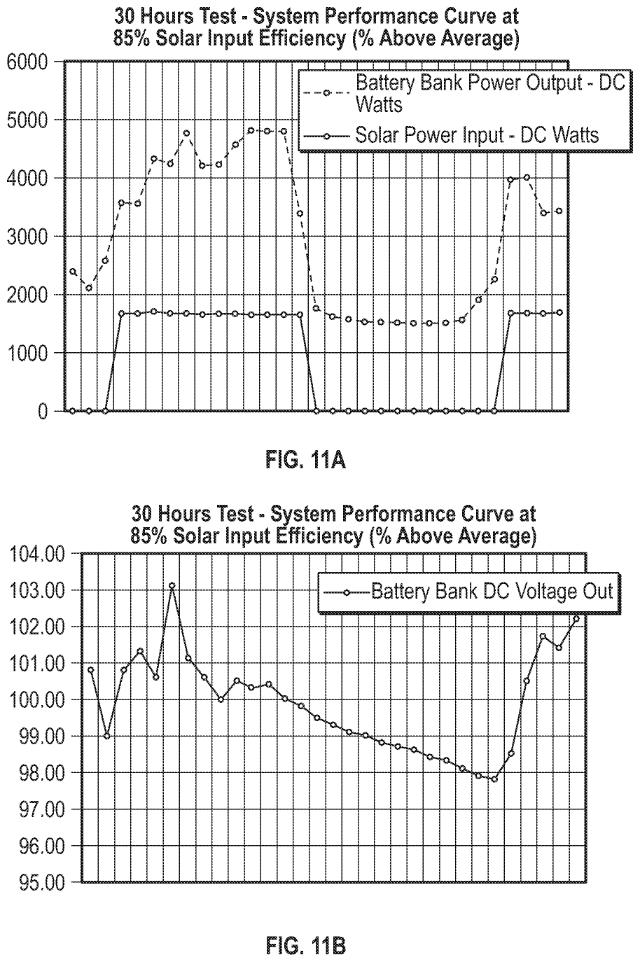

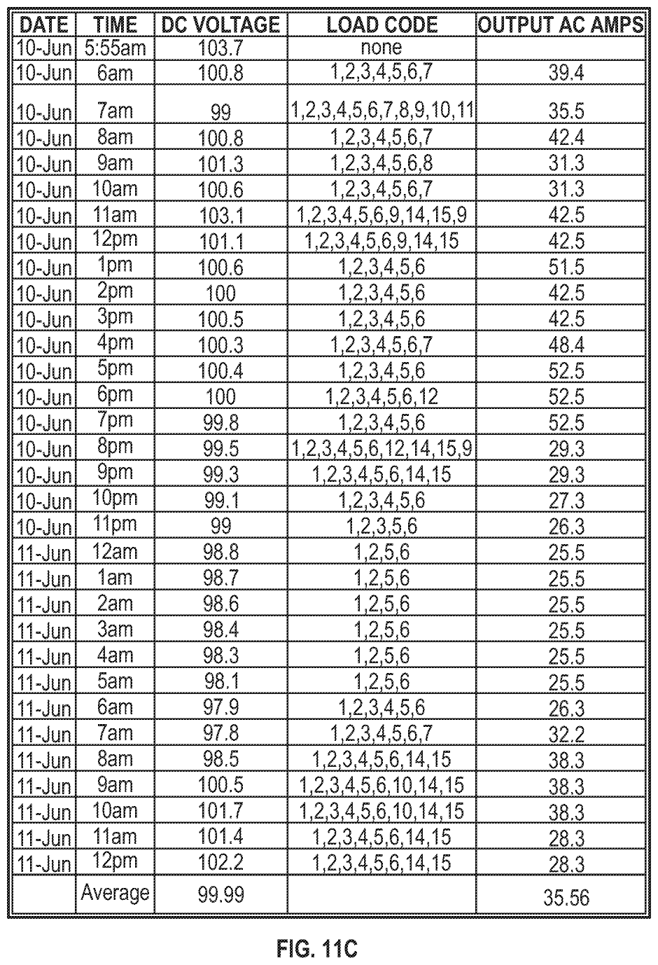

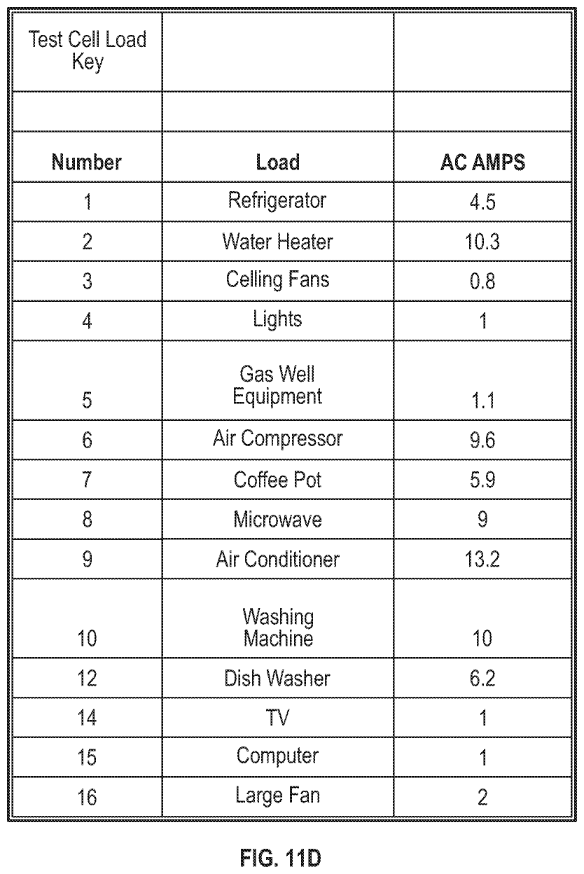

FIGS. 11A-11D illustrate test data and parameters of a 30-hour test of a MEPS unit according to one embodiment of the present disclosure. FIG. 11A illustrates system performance of the MEPS over the 30-hour test and graphically demonstrates (1) the battery bank power output and (2) the solar power input, while FIG. 11B graphically demonstrates (3) the battery bank voltage output. As shown, with no solar power input the battery bank power output still produced a certain amount of power (watts) and never fell significantly below 98%. FIG. 11C illustrates what loads (loads 1-16) were connected and powered at each hour of the 30-hour test. FIG. 11C also shows the DC voltage of the batteries and output of the system in AC amps for each of the 30 hours. FIG. 11D lists the loads (1-16) connected to the MEPS and the amperage requirement for each of the loads. The tested MEPS unit included a magnetic motor, a magnetic coupler, and a magnetic alternator as described herein, as well as a solar assembly coupled to the battery power supply. The tested MEPS unit is effectively the same system as described in FIG. 4A but without the separate charging system. The motor is a brushless DC motor (BLDC) and the alternator is a PMG AC based alternator. As illustrated in these figures, the tested MEPS unit offers increased output power based on the provided input power, the ability to provide significantly constant output power, and the ability to achieve a constant and high battery voltage even with minimal charging, all of which indicates a highly efficient and effective electrical power station.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention.

Many other variations in the configurations of an electric power station, such as the motor, alternator, coupler, battery system, charging system, and control system are within the scope of the invention. For example, a MEPS unit may contain only one magnetically enhanced device (such as a magnetic coupler), or it may contain two or three or more magnetically enhanced devices. It may be partly or wholly AC or DC based. The MEPS unit may have a magnetically enhanced device itself (motor, coupler, alternator), or it may include an external magnetic housing surrounding one of the components of the EPS. It is emphasized that the foregoing embodiments are only examples of the very many different structural and material configurations that are possible within the scope of the present invention.

Although the invention(s) is/are described herein with reference to specific embodiments, various modifications and changes can be made without departing from the scope of the present invention(s), as presently set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A magnetic electrical power storage and production system, comprising:
an electric motor;
an electrical energy generator coupled to the electric motor; and
a coupling device that couples the motor to the generator,
wherein at least one of the motor, generator, or coupling device comprises a plurality of permanent magnets configured to increase an applied magnetic field to the system.

2. The system of claim 1, wherein an output power from the generator is greater than an input power to the motor.

3. The system of claim 1, wherein an output power from the generator is greater than at least two times an input power to the motor.

4. The system of claim 1, wherein the electric motor comprises a magnetic motor.

5. The system of claim 1, wherein the motor comprises a plurality of permanent magnets.

6. The system of claim 1, wherein the motor comprises a rotor and a stator, wherein a plurality of permanent magnets is coupled to the rotor.

7. The system of claim 1, wherein the motor comprises a rotating magnetic field and a static magnetic field.

8. The system of claim 1, wherein the coupling device comprises a magnetic coupling.

9. The system of claim 1, wherein the coupling device is configured to enhance an axial torque produced from the motor.

10. The system of claim 1, wherein the coupling device comprises a plurality of permanent magnets.

11. The system of claim 1, wherein the coupling device comprises a first plurality of permanent magnets at a first radial position and a second plurality of permanent magnets at a second radial position.

12. The system of claim 1, wherein the coupling device comprises a rotating magnetic field and a static magnetic field.

13. The system of claim 1, wherein the coupling device couples an output shaft of the motor to an input shaft of the generator.

14. The system of claim 1, wherein the coupling device comprises a spider coupling.

15. The system of claim 1, wherein the generator comprises a rotor and a stator, wherein a plurality of permanent magnets is coupled to the stator.

16. The system of claim 1, wherein the generator comprises a rotor and a stator, wherein a first plurality of permanent magnets is coupled to the stator and a second plurality of permanent magnets is coupled to the rotor.

17. The system of claim 1, wherein the generator comprises a rotor, a stator, and a housing at least partially surrounding an input shaft to the generator, wherein the housing comprises a plurality of permanent magnets.

18. The system of claim 1, wherein each of the electrical motor and coupling device comprises a plurality of permanent magnets.

19. The system of claim 1, wherein each of the electrical motor, generator, and coupling device comprises a plurality of permanent magnets.

20. The system of claim 1, further comprising a plurality of battery banks coupled to the motor.

21. The system of claim 20, further comprising a charging system coupled to the plurality of battery banks, wherein the charging system is configured to provide input of electrical energy to at least one of the battery banks.

22. The system of claim 21, wherein the charging system is configured to generate a rate of charge greater into one of the plurality of battery banks than the rate of discharge of another one of the plurality of battery banks.

23. The system of claim 20, wherein electrical energy produced from the generator is provided to one or more external loads and at least one of the plurality of battery banks simultaneously.

24. The system of claim 20, wherein the plurality of battery banks comprises a first set of battery banks and a second set of battery banks, wherein the first set of battery banks is discharged while the second set of battery banks is charged.

25. The system of claim 20, wherein the plurality of battery banks comprises a first set of battery banks and a second set of battery banks, wherein the first set of battery banks is discharged to the motor while the second set of battery banks is charged by a solar assembly.

26. The system of claim 25, wherein the rate of charge is greater than the rate of discharge.

27. The system of claim 1, further comprising a solar assembly, wherein the solar assembly comprises one or more solar panels.

28. The system of claim 1, wherein the generator is coupled to one or more external loads.

29. The system of claim 1, further comprising a control system configured to adjust an input power provided to the motor to regulate an output power produced by the generator.

30. The system of claim 1, further comprising a control system configured to adjust an input power provided to the coupling device to regulate a torque produced by the motor.

31. The system of claim 1, further comprising a magnetic housing comprising a plurality of permanent magnets, wherein the magnetic housing is positioned around and external to at least one of the motor or generator.

32. The system of claim 1, further comprising a magnetic housing comprising a plurality of permanent magnets, wherein the magnetic housing is positioned around and external to at least one of an output shaft to the electric motor and an input shaft to the electrical energy generator.

33. The system of claim 1, wherein the coupling device comprises a first magnetic coupling device and a second magnetic coupling device.

34. The system of claim 33, wherein the first magnetic coupling device is coupled to the second magnetic coupling device in series.

35. The system of claim 33, wherein the first magnetic coupling device couples an output shaft of the motor to an input shaft of the second magnetic coupling device, and the second magnetic coupling couples an output shaft of the first magnetic coupling device to an input shaft of the generator.

36. The system of claim 33, wherein each of the first and second magnetic coupling devices comprises a plurality of permanent magnets.

37. The system of claim 33, wherein each of the first and second magnetic coupling devices comprises a rotating magnetic field and a static magnetic field.

38. A magnetic electrical power storage and production system, comprising,
an electric motor;
an electrical energy generator coupled to the electric motor;
a coupling device that couples an output shaft of the motor to an input shaft of the generator;
at least one magnetic housing comprising a plurality of permanent magnets configured to increase an applied magnetic field to the system, wherein the magnetic housing is coupled to at least one of the motor or the generator.

39. The system of claim 38, wherein the at least one magnetic housing is positioned around and external to the motor.

40. The system of claim 38, wherein the at least one magnetic housing is positioned around and external to the generator.

41. The system of claim 38, wherein the at least one magnetic housing comprises a first magnetic housing positioned around and external to the motor and a second magnetic housing positioned around and external to the generator.

42. The system of claim 38, wherein the at least one magnetic housing is coupled to an input shaft to the generator, wherein the at least one magnetic housing comprises a first plurality of permanent magnets coupled to the input shaft and a second plurality of permanent magnets that remain substantially fixed.

43. The system of claim 38, wherein the at least one magnetic housing is coupled to an output shaft of the motor, wherein the at least one magnetic housing comprises a first plurality of permanent magnets coupled to the output shaft and a second plurality of permanent magnets that remain substantially fixed.

44. A method of providing electrical energy, comprising
energizing an electric motor;
coupling the electric motor to a generator with a coupling device;
providing an output power from the generator that is greater than the input power to the electric motor based on an enhanced magnetic flux provided by a plurality of permanent magnets.

45. The method of claim 44, wherein the plurality of permanent magnets is coupled to a rotor of the electric motor.

46. The method of claim 44, wherein the plurality of permanent magnets is coupled to a stator of the generator.

47. The method of claim 44, wherein the plurality of permanent magnets is located within the coupling device.

48. The method of claim 44, wherein the plurality of permanent magnets is located within a least one magnetic housing positioned around and external to at least one of the motor or the generator.

49. A method of providing electrical energy, comprising
energizing an electric motor with current from at least one of a plurality of battery banks to provide rotation of an output shaft of the electric motor;
coupling an output shaft of the motor to an input shaft of a generator;
generating power from the generator based on rotation of the output shaft of the motor; and
providing an enhanced magnetic flux by utilizing a plurality of permanent magnets.

50. The method of claim 49, wherein the coupling step comprises utilizing one or more magnetic couplers.

51. The method of claim 49, further comprising providing an output power from the generator that is greater than the input power to the electric motor.

52. The method of claim 51, wherein the output power is greater than at least two times than the input power.

53. The method of claim 49, further comprising reducing electrical power provided to the electric motor to maintain approximately the same electrical output provided by the generator.

54. The method of claim 49, further comprising adjusting electrical power provided to the electric motor to maintain a desired output power provided by the generator.

55. The method of claim 49, further comprising increasing an axial torque produced by the motor by utilizing a magnetic coupling device between the motor and the generator.

56. The method of claim 49, further comprising increasing an axial torque produced by the motor based on the plurality of permanent magnets.

57. The method of claim 49, further comprising providing a rotating magnetic field and a static magnetic field by the use of the plurality of permanent magnets.

58. The method of claim 49, further comprising charging the one or more battery banks based on power provided by the generator.

59. The method of claim 49, further comprising regulating the power provided to one or more external loads to maintain a predetermined battery charge threshold on the one or more battery banks.

60. The method of claim 49, further comprising regulating the power provided to the electrical motor to maintain a predetermined battery charge threshold on the one or more battery banks.

61. The method of claim 49, further comprising providing electrical power to a magnetic coupling device to increase an axial torque provided by the motor.

62. The method of claim 49, further comprising providing electrical power to a magnetic coupling device while providing electrical power to the motor.

63. The method of claim 49, further comprising reducing electrical power provided to the motor to stabilize output power from the generator.

64. The method of claim 49, further comprising providing pulsating electrical power to the electrical motor to maintain system output.

65. The method of claim 49, further comprising providing pulsating electrical power to the electrical motor to maintain a substantially constant output power from the generator.

66. The method of claim 49, further comprising enhancing the performance characteristics of the motor or generator by applying a permanent magnetic field within the motor or generator based on the plurality of permanent magnets.

67. The method of claim 49, further comprising providing electrical energy from a solar array to the one or more battery banks.
